(19) United States
(12) Patent Application Publication
(10) Pub. No.: US 2026/0039343 A1
(43) Pub. Date: Feb. 5, 2026

(54) ENHANCED COORDINATED BEAMFORMING FOR WIRELESS COMMUNICATIONS

(71) Applicant: Intel Corporation, Santa Clara, CA (US)

(72) Inventors: Dmitry Akhmetov, Hillsboro, OR (US); Danny Alexander, Neve Efraim Monoson (IL); Danny Ben-Ari, Hasharon Hatichon (IL); Laurent Cariou, Milizac (FR); Dibakar Das, Hillsboro, OR (US); Juan Fang, Portland, OR (US); Po-Kai Huang, San Ramon, CA (US); Qinghua Li, San Ramon, CA (US); Yonathan Segev, Sunnyvale, CA (US); Shlomi Vituri, Tel Aviv (IL)

(21) Appl. No.: 19/351,190

(22) Filed: Oct. 6, 2025

Related U.S. Application Data
(60) Provisional application No. 63/704,373, filed on Oct. 7, 2024.
(60) Provisional application No. 63/717,604, filed on Nov. 7, 2024.
(60) Provisional application No. 63/722,900, filed on Nov. 20, 2024.

(51) Int. Cl. H04B 7/06; H04L 69/323

(52) U.S. Cl. CPC H04B 7/0617; H04L 69/323

(57) ABSTRACT

This disclosure describes systems, methods, and devices related to coordinated beamforming between multiple access points using a transmission opportunity of one access point shared with at least one additional access point. The access points may exchange information to coordinate transmissions of data to associated station devices, and may provide signaling to each other and to the station devices regarding the coordinated beamforming operation.

### CROSS-REFERENCE TO RELATED PATENT APPLICATION(S)

This application claims the benefit of U.S. Provisional Application No. 63/704,373, filed Oct. 7, 2024, U.S. Provisional Application No. 63/717,604, filed Nov. 7, 2024, and U.S. Provisional Application No. 63/722,900, filed Nov. 20, 2024, the disclosures of which are incorporated herein by reference as if set forth in full.

### BACKGROUND

Wireless devices are becoming widely prevalent and are increasingly requesting access to wireless channels. The Institute of Electrical and Electronics Engineers (IEEE) is developing one or more standards that utilize Orthogonal Frequency-Division Multiple Access (OFDMA) in channel allocation.

### BRIEF DESCRIPTION OF THE DRAWINGS

FIG. 1A is a network diagram illustrating an example network environment, in accordance with one or more example embodiments of the present disclosure.

FIG. 1B depicts an illustrative schematic diagram for multi-link device (MLD) communications between two logical entities, in accordance with one or more example embodiments of the present disclosure.

FIG. 1C depicts an illustrative schematic diagram for MLD communications between an access point (AP) MLD with logical entities and a non-AP MLD with logical entities, in accordance with one or more example embodiments of the present disclosure.

FIG. 2 shows an example coordinated beamforming (CBF) sequence, in accordance with one or more example embodiments of the present disclosure.

FIG. 3 shows an example CBF sequence, in accordance with one or more example embodiments of the present disclosure.

FIG. 4 shows an example CBF sequence, in accordance with one or more example embodiments of the present disclosure.

FIG. 5 shows an example CBF data transmission with three phases, in accordance with one or more example embodiments of the present disclosure.

FIG. 6A shows one option for the data transmission phase of FIG. 5, in accordance with one or more embodiments of the present disclosure.

FIG. 6B shows one option for the data transmission phase of FIG. 5, in accordance with one or more embodiments of the present disclosure.

FIG. 6C shows one option for the data transmission phase of FIG. 5, in accordance with one or more embodiments of the present disclosure.

FIG. 7 shows an example process of a flow for coordinated beamforming, in accordance with one or more embodiments of the present disclosure.

FIG. 8 shows a functional diagram of an exemplary communication station 300, in accordance with one or more example embodiments of the present disclosure.

FIG. 9 illustrates a block diagram of an example machine upon which any of one or more techniques (e.g., methods) may be performed, in accordance with one or more example embodiments of the present disclosure.

FIG. 10 is a block diagram of a radio architecture in accordance with some examples.

FIG. 11 illustrates an example front-end module circuitry for use in the radio architecture of FIG. 10, in accordance with one or more example embodiments of the present disclosure.

FIG. 12 illustrates an example radio IC circuitry for use in the radio architecture of FIG. 10, in accordance with one or more example embodiments of the present disclosure.

FIG. 13 illustrates an example baseband processing circuitry for use in the radio architecture of FIG. 10, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

The IEEE 802.11 technical standards define communications for Wi-Fi, including for beamforming and for Enhanced Multilink Single-Radio (EMLSR) operations. The IEEE 802.11ac and 802.11n standards define Wi-Fi® beamforming, which allows an access point (AP) to direct signals toward station devices (STAs) in specific directions to improve signal strength and throughput. 802.11n introduced multiple-input multiple-output (MIMO) communications, which multiplied transmission rates by using multi-antenna transmissions. APs typically include more antennae than STAs, so when an AP transmits to an STA, multi-antenna gain was not realized until beamforming was introduced with multi-user MIMO (MU-MIMO). The IEEE 802.11be standard defines EMLSR operations, which allow a multi-link device (MLD) to use a single radio to simultaneously manage multiple links across different frequency bands. MLDs are physical devices such as APs and STAs that include multiple logical STAs (which can serve as logical APs or STAs) each capable of using their own links with another logical STA at another MLD simultaneously with another logical STA at a same MLD. A MLD is a logical entity that contains one or more station devices (STAs). The logical entity has one medium access control (MAC) data service interface and primitives to the logical link control (LLC), and a single address associated with the interface, which can be used to communicate on the distribution system medium (DSM). A MLD may allow multiple STAs within the MLD to have a same MAC address. In an infrastructure framework, there may be an MLD whose logical entities are APs (e.g., an A-MLD) on one side, and a MLD on the other side (e.g., a non-AP MLD, referring to a MLD whose logical entities are non-AP STAs). For example, an A-MLD (or AP MLD) may refer to a MLD in which each STA in (e.g., affiliated with the MLD) the AP MLD is an extremely high throughput (EHT) AP, and a MLD (non-AP MLD) may refer to a MLD whose STAs within (e.g., affiliated with) the MLD are non-AP EHT STAs.

The IEEE 802.11bn standard (Wi-Fi 8—Ultra High Reliability UHR) is introducing a concept of coordinated beamforming (CoBF or CBF), which involves two or more APs sending data synchronously over the same frequency channel (and at the same time) using beamforming and nulling. In CBF, information needs to be exchanged among the APs to enable the spatially multiplexed transmissions, and the exchanges are needed for both the channel sounding phase and the data transmission phase. 802.11bn may also introduce interference mitigation (MI) as a physical layer (PHY) feature. Signaling in a PHY protocol data unit (PPDU) preamble needs to be defined in 802.11bn. Designs supporting other new PHY features such as unequal modulation and distributed Resource Unit (dRU—a logical RU distributed across a set of noncontiguous subcarrier indices) are shown below in Tables 1-8. CBF allows APs to share information such as channel state information (CSI) with each other to manage their transmissions and mitigate interference. CBF allows APs to direct their beams to their associated users and to null their transmissions in directions of non-associated STAs.

TABLE 1
U-SIG 1 Field of 802.11 non-ELR PPDU:

| Bit 0- | Bit 3- | | Bit 7- | Bit 13- | Bit 20- | |
|---|---|---|---|---|---|---|
| Bit 2 | Bit 5 | Bit 6 | Bit 12 | Bit 19 | Bit 24 | Bit 25 |
| PHY | PPDU | UL/DL | BSS | TXOP | Disregard | Validate |
| Version | Bandwidth | | Color | | | |

TABLE 2
U-SIG 2 Field of 802.11 non-ELR PPDU:

| Bit 0- | | Bit 3- | | Bit 9- | Bit 11- | Bit 16- | Bit 20- |
|---|---|---|---|---|---|---|---|
| Bit 1 | Bit 2 | Bit 7 | Bit 8 | Bit 10 | Bit 15 | Bit 19 | Bit 25 |
| PPDU | Vali- | Punc- | Vali- | EHT- | Number | CRC | Tail |
| Type | date | tured | date | SIG | of EHT- | | |
| | | Channel | | MCS | SIG | | |
| | | Info | | | Symbols | | |

TABLE 3
U-SIG 1 Field of 802.11 ELR PPDU:

| Bit 0- | Bit 3- | | Bit 7- | Bit 13- | Bit 20- | |
|---|---|---|---|---|---|---|
| Bit 2 | Bit 5 | Bit 6 | Bit 12 | Bit 19 | Bit 24 | Bit 25 |
| PHY | PPDU | UL/DL | BSS | TXOP | Disregard | Validate |
| Version | Bandwidth | | Color | | | |

TABLE 4
U-SIG 2 Field of 802.11 ELR PPDU:

| Bit 0- | Bit 2- | Bit 13- | Bit 16- | |
|---|---|---|---|---|
| Bit 1 | Bit 12 | Bit 15 | Bit 19 | Bit 20-Bit 25 |
| PPDU | STA-ID | ELR | CRC | Tail |
| Type: | | Validate | | |
| ELR | | | | |

TABLE 5
User Field for 802.11 MU-MIMO Allocation:

| Bit 0- | Bit 11- | | | | |
|---|---|---|---|---|---|
| Bit 10 | Bit 15 | Bit 16-Bit 19 | Bit 20 | Bit 21 | Bit 22 |
| STA-ID | MCS | Spatial | Res | Coding | 2xL DPC |
| | | Configuration | | | |

TABLE 6
User Field for 802.11 non-MU-MIMO Allocation:

| Bit 0- | Bit 11- | Bit 16- | | Bit 20- | |
|---|---|---|---|---|---|
| Bit 10 | Bit 15 | Bit 18 | Bit 19 | Bit 21 | Bit 22 |
| STA-ID | MCS | NSS | EQM | UEQM | If B21 indicates |
| | | | | Pattern | LDPC: |
| | | | | BF | 0: Legacy LDPC |
| | | | | 0: BCC | 1: 2x LDPC |
| | | | | 1: LDPC | |

TABLE 7
Common Field for 802.11 non-OFDMA Transmission:

| Bit 0- | Bit 5- | Bit 6- | | Bit 10- | | Bit 13- | Bit 16- |
|---|---|---|---|---|---|---|---|
| Bit 3 | Bit 5 | Bit 8 | Bit 9 | Bit 11 | Bit 12 | Bit 15 | Bit 18 |
| Spatial | GI + LTF | Number of | LDPC | Pre-FEC | PE | Disregard | Number |
| Reuse | Size | UHR-LTF | Extra | Padding | Disambiguity | | of non- |
| | | Symbols | Symbol | Factor | | | OFDMA |
| | | | Segment | | | | Users |

TABLE 8
ELR-SIG for ELR PPDU:

| | | | | | Bit 4- | | Bit 14- | Bit 18- |
|---|---|---|---|---|---|---|---|---|
| | Bit 0 | Bit 1 | Bit 2 | Bit 3 | Bit 12 | Bit 13 | Bit 17 | Bit 23 |
| ELR- | ELR- | UL/DL | MCC | Coding | Length | LDPC | CRC | Tail |
| SIG-1 | version | | | | (number of | extra | | |
| | (0 for | | | | OFDM data | OFDM | | |
| | UHR | | | | symbols −1) | Symbol | | |
| | ELR | | | | | | | |
| | PPDU) | | | | | | | |

| | Bit 0- | Bit 11- | Bit 14- | Bit 18- |
|---|---|---|---|---|
| | Bit 10 | Bit 13 | Bit 17 | Bit 23 |
| ELR- | STA-ID | Reserved | CRC | Tail |
| SIG-2 | | (Disregard) | | |

One proposal for the CBF sequence includes a sharing AP1 (e.g., the AP who has won access to a channel, also referred to as a coordinating AP or a primary AP) and a shared AP2 (e.g., another AP allowed to share the channel won by the sharing AP, also referred to as a coordinated AP or secondary AP), and STA1 and STA2 as users of AP1 and AP2, respectively. AP1 sends a CBF trigger frame (TF), including PPDU parameters for aligning the CBF transmission and a final stream allocation in sharing the BSS of AP1. AP2 then sends a CBF confirm message acting as an acknowledgement of the CBF trigger with PPDU parameters and a final stream allocation in sharing the BSS of AP2. AP1 optionally may send a sync frame to synchronize subsequent CBF transmissions from the AP1 and AP2 (e.g., synchronize their clocks), and then AP1 and AP2 may send their CBF transmissions in a synchronized manner. The APs and STAs then may send acknowledgments as block acknowledgements (BAR-BAs) or one BSS at a time.

The present disclosure proposes multiple signaling designs to support CBF and IM.

In some other proposals, where bits B20-B25 of the U-SIG1 field are used to signal a second BSS color, legacy STAs cannot read the second BSS color and therefore may interpret the CBF PPDU as an OBSS PPDU without properly setting the NAV. The enhanced signaling herein addresses this issue.

In addition, for a CBF sequence it is expected that a CBF invite message will be defined by 802.11bn along with a CBF response that follows the CBF invite. A sharing AP may invite a shared AP (a CBF invite) and then after receiving a CBF response may send a confirmation message (e.g., CBF sync) before the two APs send a DL PPDU to respective associated STAs (e.g., STAs respectively associated to the respective APs). However, it is unclear how EMLSR STAs will be supported in this sequence. In a baseline EMLSR, each STA is required to receive an ICF (e.g., MURTS or BSRP TF) before the STA may receive a DL PPDU that includes data frames. This raises the following questions about how to support EMLSR STAs within a CBF sequence.

First, where should the ICF-ICR exchange be inserted? Second, how long with EMLSR STAs associated to sharing AP1 and shared AP2 wait before switching to listen mode? What baseline rules will make the former switch when they see the ICF from shared AP2 that is not addressed to them and the latter if they do not receive a CBF sync? How can it be ensured that a Wi-Fi 8 STA associated to shared AP2 does not attempt to perform NPCA after receiving the CBF response? How can it be ensured that STAs associated to shared AP2 respond to the ICF sent to them (and not have their NAV blocked because of transmissions from sharing AP1)? The present disclosure provides solutions to these issues.

The ICF refers to an initial control frame (ICF) used as part of the 802.1be EMLS operation. EMSLR allows a device with a single radio to quickly switch between multiple links, and the ICF is sent by the AP to the STA to initiate the switching process and signal the channel availability. The ICR refers to the initial control reply (ICR) sent in response to the ICF.

In EMLSR, an STA may listen to two different links simultaneously while transmitting on a single link at a given time. After completing a data transmission, the STA returns to the simultaneous listening mode on multiple links. The second question above concerns how long an EMLSR STA should wait before switching to the listening mode.

In one or more embodiments, the content and MCS (modulation and coding scheme) of the pre-UHR-STF portion of the CBF PPDU preamble may need to be the same for the sharing and shared APs. The APs may need to exchange information for generating the same waveform for the pre-UHR-STF portion, which includes L-STF, L-LTF, L-SIG, RL-SIG, U-SIG, and UHR-SIG (or EHT-SIG) fields.

In one or more embodiments, the CBF data transmission may consist of three phases of SIFS duration apart from each other (or a longer separation). The three phases may be a scheduling phase followed by a data transmission phase followed by an acknowledgement phase. The sharing and shared APs may perform user scheduling or user grouping of a few frames a few milliseconds before the data transmission phase.

Before the CBF scheduling phase is a channel training phase. After the channel training phase, the CBF APs receive vectors or matrices for beamforming and nulling used in the data transmission phase. In the scheduling phase, the APs may exchange the buffer status of the candidate users. The sharing AP may send the shared AP the following during the scheduling phase: (1) The AIDs of the users of the sharing AP and that have buffered data at the sharing AP (e.g., the AIDs of the STAs to receive the subsequent CBF data transmission). (2) The AIDs of the users of the shared AP and whose nulling vectors are available at the sharing AP. (3) The buffer status of the users in (1) (e.g., queue size and/or access category). (4) Restrictions on the user grouping imposed by the sharing AP. Similarly, the shared AP may send the following to the sharing AP: (5) The AIDs of the users of the shared AP and who have buffered data at the shared AP. (6) The AIDs of the users of the sharing AP and whose nulling vectors are available at the shared AP. (7) The buffer status of the users in (5) (e.g., queue size and/or access category). (8) Restrictions on the user grouping imposed by the shared AP.

Because the desired user and the OBSS user may be in similar directions, the AP may not be able to perform beamforming to the desired user while doing the nulling to the OBSS user. Therefore, there may be some restrictions in grouping the users across BSSs. The APs may exchange lists of incompatible users for the user grouping. Besides the user scheduling, the AP may wake up users during scheduling phase. For example, the AP may send an ICF to a power-save user (e.g., an STA in a power save mode), which may use ELMSR, to move the user's reception capability from low to high. The user may respond to the ICF by an ICR acknowledging the request.

In one or more embodiments, in the data transmission phase after the scheduling phase, the sharing AP and the shared AP may conduct one data transmission phase and one acknowledgement phase, or the two APs may repeat the data transmission phase and acknowledge phase for multiple times. There are multiple options for the data transmission phase. In one option, the data transmission phase consists of CBF trigger, confirmation, sync frame, and CBF transmission. In another option, ELMSR is used. The AP needs to bring the user from low capability mode to high capability mode. In some options, the trigger immediately precedes CBF data transmission. For the data bursts after the first within the TXOP for the same group of users, ICF and ICR may not be sent before the CBF data transmission because the users already brought up the reception capabilities by the initial ICF/ICR.

In one or more embodiments, for backward compatibility, the EHT frames may be used for UHR. For example, an EHT NDPA can be reused for UHR. Similarly, the present disclosure proposes to reuse EHT sounding NDP for UHR NDP sounding. Furthermore, because of the similarity of CBF transmission and the legacy downlink (DL) MU-MIMO transmission, the EHT DL MU-MIMO may be reused for UHR CBF transmission. If so, the legacy EHT devices can also join the CoBF sounding/feedback and receive data from UHR CoBF mode. Otherwise, UHR DL MU-MIMO transmission may be used for UHR CoBF transmission.

In one or more embodiments, the trigger frame used in the CBF sequence (CBF trigger frame) may include the following information: (1) Shared AP ID: for example, the shared AP's AID that is assigned by the sharing AP or the shared AP's MAC (medium access control) address. (2) IDs of all the scheduled users in a CBF data PPDU, for example, the AIDs of the scheduled users. (3) Resource allocation in frequency, space, and time for all scheduled users, for example, the spatial stream allocation, the bandwidth of the CBF data PPDU, punctured channel information, and PPDU duration (e.g., an L-SIG length field value). (4) Values or configuration parameters for the subfields in the CoBF data PPDU preamble like L-SIG, U-SIG, and UHR-SIG (or CBF-SIG). The subfields are other than the resource allocation subfields above. Because the sharing and shared APs need to send the same signal for the preamble portion of the PPDU before the UHR-STF, the configurations and subfield values of the portion need to be known by the shared AP. (5) Other information such as transmission power of the shared AP and the shared AP's carrier sensing before transmission.

In one or more embodiments, the CBF trigger frame may request another device to send a PPDU similar to the way that a legacy 802.11 trigger frame triggers UL trigger-based transmissions except that the legacy trigger-based transmission is sent to an AP and the CBF transmission is sent to STA(s). For backward compatibility, the trigger frame for EHT/HE trigger-based transmission may be reused. The trigger frame format of the EHT/HE is shown below in Table 9. The TA (transmitter address) should be set to the MAC address of the sharing AP. The RA (receiver address) may be set to the MAC address of the shared AP or to a broadcast address. Setting the RA to the MAC address of the shared AP results in the non-AP STA not needing to read the trigger frame.

TABLE 9
802.11 EHT/HE Trigger Frame Format:

| | Field | | | | | | | |
|---|---|---|---|---|---|---|---|---|
| | | | | | | User | | |
| | Frame | | | | Common | Info | | |
| | Control | Duration | RA | TA | Info | List | Padding | FCS |
| Octets | 2 | 2 | 6 | 6 | 8 or | Variable | Variable | 4 |
| | | | | | more | | | |

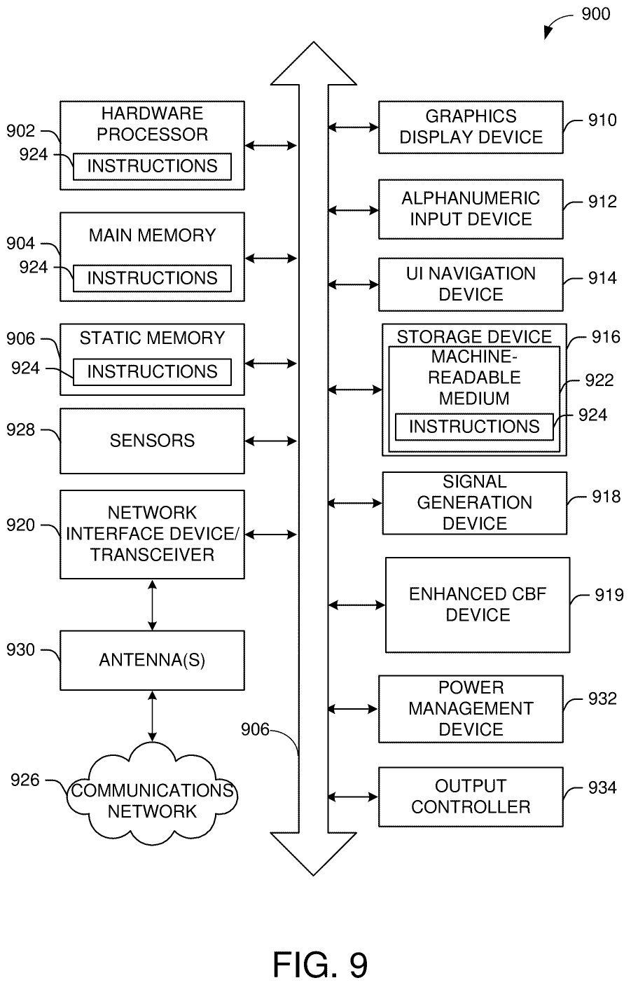

The common info field of the EHT/HE trigger frame from Table 9 above is defined in FIG. 9-64b of the IEEE 802.11ax 2021 standard. The user info list from Table 9 above includes a sequence of zero or more user info fields, each of which is defined in FIG. 9-64d of the IEEE 802.11ax 2021 standard. The EHT/HE trigger frame of a trigger-based transmission is for soliciting uplink transmission. In contrast, the CBF trigger frame is for soliciting the shared AP's downlink transmission. Some modifications to the EHT/HT trigger frame are therefore needed. For example, the legacy subfields defining uplink parameters should be changed to the ones defining the corresponding downlink parameters, and the same changes should be applied to the user info field.

An indication of the CBF trigger frame is needed. The simplest option is to add an entry for CBF trigger in the trigger type subfield of Table 9-29c of the IEEE 802.11ax 2021 standard (in which the trigger type subfield values 8-15 are reserved) and 802.11az adds a ranging type trigger frame at trigger type subfield value 8 so one of types 9-15 could be used to signal a CBF type trigger frame). With the new trigger type value of CBF, the new frame format for a CBF trigger may be defined. The common info field and the user info field may be tailored for CBF trigger. Even though a new trigger type of CBF may be defined, some of the subfields like UL spatial reuse at bits 37-52 in the common info field may not be changed. Even though a non-AP STA may not understand the new CBF trigger frame, the STA may still use the UL spatial reuse subfield and maybe additional subfields (e.g., AP Tx Power subfield) for spatial reuse.

One option for reusing an existing 802.11 trigger frame format is the basic trigger frame variant, whose trigger type value is 0. This format is also used by the trigger frame of an uplink trigger-based transmission in HE (high-efficiency—802.11ax) and extremely high throughput (EHT—802.11be). To differentiate between EHT and HE trigger frames, three bits in the common info field and user info field are used as shown in Table 10 below. This approach may be used to signal the CBF trigger frame. Note that only five combinations are used in Table 10 such that there are three unused combinations. For example, bits B54 and B55 in the common info field and bit B39 of the user info field are all set to 1 to signal the CBF trigger frame. Because the RA may be set to the MAC address of the AP, the AP receiver should identify the trigger frame as a CBF trigger frame type and not EHT or HE whose receiver is always a non-AP STA. Therefore, there is no need for signaling except for setting the RA to an AP MAC address for the CBF trigger frame.

TABLE 10
Valid Combinations of Bits B54 and B55 in the Common
Info Field and Bit B39 in the User Info Field,
and Solicited Trigger-Based PPDU Format:

| Common | Common | User | Presence of | User Info | TB |
|---|---|---|---|---|---|
| Info Field | Info Field | Info | Special User | Field | PPDU |
| B54 | B55 | Field B39 | Info Field | Variant | Type |
| 1 | 1 | 0 | No | HE variant | HE |
| 0 | 0 | 0 | Yes | EHT variant | EHT |
| 0 | 0 | 1 | Yes | EHT variant | EHT |
| 1 | 0 | 1 | Yes | EHT variant | EHT |
| 1 | 0 | 0 | Yes | HE variant | HE |

The common info field of the EHT trigger frame variant is defined by FIG. 9-90b of 802.11be. The trigger dependent common info subfield is not present in the basic trigger frame, which may be reused herein.

Because some information is missing the Common Info field, one or multiple Special User Info fields may be sent after the Commo Info field. The Special User Info Field Flag subfield is set to 0 in an EHT variant Common Info field, indicating that a Special User Info field is included in the CBF Trigger frame that includes the EHT variant Common Info field. For EHT, the Special User Info field is identified by an AID12 value of 2007, whose format is shown in FIG. 9-90d of 802.11be. Note that Trigger Dependent User Info subfield with 8 bits is present in the Special User Info field. Because the Special User Info field is for the shared AP not scheduled STA, the 8 bits of the subfield can be repurposed. For CBF, AID12 of Special User Info field does not need to be 2007. Instead, it can be one of the reserved numbers unused by EHT or HE. Because the shared AP knows the first User Info field is a Special User Info field, the AID 12 does not need to be the special value like 2007.

If sending additional information like BSS Color and Punctured Channel Information, which are U-SIG subfields, is desired, some bits in the Common Info field and Special User Info field (except the Spatial Reuse bits) may be repurposed. For example, the 12 bits of AID12 and the 8 bits of Trigger Dependent User Info shown in FIG. 9-96 of 802.11be may be repurposed. The repurposed 20 bits of AID12 and Trigger Dependent User Info can be used to send the configuration parameters for generating the preamble of the CBF data PPDU and other information, which may include some or all of the following: BSS color of sharing AP (6 bits), BSS color of shared AP (6 bits), punctured channel information (5 bits), TXOP duration (7 bits), version of CBF trigger (1-3 bits), MCS of EHT-SIG or UHR-SIG of the CBF PPDU (1-2 bits), number of EHT-SIG or UHR-SIG symbols of the CBF PPDU (3-4 bits), number of CBF users (2 bits), information related to ELMSR (e.g., whether ICF and ICR are required before transmitting CBF data PPDU). The number of bits of the above information signaled in the CBF trigger frame may differ, and the numbers of bits provided above are exemplary but not required.

Some of the parameters above may not need to be sent because they are static and do not vary for long period of time or they can be derived from other subfields in the CoBF trigger frame. The shared AP, the receiver of the CoBF trigger frame, can determine the unsent information like BSS Color(s) and Punctured Channel Information from the information it captured from previous frames like Beacon frame and association frame, because this kind of information remains static or unchanged for long time. For example, the BSS colors may not be sent. For another example, the TXOP duration (7 bits) above is for filling the corresponding subfield in the U-SIG field of the CoBF data PPDU. The value of the TXOP duration (7 bits) may be derived from the Duration (16 bits) in FIG. 9-90 of 802.11be and thus the TXOP duration (7 bits) may not be sent. For a third example, the Punctured Channel Information (5 bits) may be static. Besides, it may be derived from the RA Allocation subfield in the User Info field, whose example of EHT is shown in FIG. 9-90i of 802.11be. Because CoBF trigger frame carries information about the resource allocation of each user scheduled in the CoBF data PPDU, there are respective User Info fields in the CoBF trigger, which specify the RU or mRU size and position of CoBF transmission. The size and position of the RU or mRU implicitly specifies the punctured subchannel(s). For a fourth example, the Number of EHT-SIG or UHR-SIG Symbols may be derived from the MCS of EHT-SIG or UHR-SIG and the number of User Info fields in the CoBF trigger frame. In summary, one Special User Info may be enough for carrying information leftover from the Common User Info field.

If existing bits are not to be repurposed, another special user info field may be added and some or all of the bits in the additional special user info field may be repurposed. A special AID, not used by a normal user, may be used by the added special user info field. Table 11 shows the special user info field format.

TABLE 11
802.11 Special User Info Field Format:

| | Field | | | | | | | |
|---|---|---|---|---|---|---|---|---|
| | | PHY | | EHT | EHT | U-SIG | | Trigger |
| | | Version | UL BW | Spatial | Spatial | Disregard | | Dependent |
| | AID12 | Identifier | Extension | Reuse 1 | Reuse 2 | and Validate | Reserved | User Info |
| Bits | B 0-B 11 | B 12-B 14 | B 15-B 16 | B 17-B 20 | B 21-B 24 | B 25-B 36 | B 37-B 39 | Variable |

The values of some subfields of L-SIG, U-SIG, and UHR-SIG (or CoBF-SIG) may not be specified in the CoBF trigger frame. These subfields can be filled in by the sharing and shared APs according to predefined rules in UHR spec. For example, the MCS subfield of the L-SIG field should be MCS 0. DL/UL of U-SIG should be set to DL, i.e., 0. The U-SIG subfield of PPDU Type and Compression Mode should be set for downlink MU-MIMO. Specifically, if the U-SIG of CoBF is similar to the one of EHT, it is desired to set the PPDU Type and Compression Mode to 2 as shown in Table 12 for downlink non-OFDMA MUMIMO.

TABLE 12
Combination of UL/DL and PPDU Type and Compression Mode Field:

| | | Description | | | | |
|---|---|---|---|---|---|---|
| | | | | | Total | |
| | | | | | Number of | |
| UL-SIG Fields | | | | | User Fields | |
| | PPDU Type | | | RU | in MU | |
| | and | EHT | | Allocation | PPDU or | |
| | Compression | PPDU | EHT-SIG | Subfields | Transmitters | |
| UL/DL | Mode | Format | Present? | Present? | in TB PPDU | Note |
| 0 (DL) | 0 | EHT MU | Yes | Yes | ≥1 | |
| | 1 | EHT MU | Yes | No | 1 for EHT | EHT SU |
| | | | | | SU | transmission |
| | | | | | transmission | or EHT |
| | | | | | 0 for EHT | sounding |
| | | | | | sounding | NDP not |
| | | | | | NDP | addressed to |
| | | | | | | an AP |
| | | | | | | NOTE: one |
| | | | | | | such case is |
| | | | | | | DL |
| | | | | | | transmission |
| | | | | | | from AP to |
| | | | | | | non-AP |
| | | | | | | STA |
| | 2 | EHT MU | Yes | No | >1 | DL non- |
| | | | | | | OFDMA |
| | | | | | | MU-MIMO |
| | 3 | — | — | — | — | Validate |

The user info field of the EHT trigger frame is shown in Table 13 below. For backward compatibility, the EHT user info field may be reused or may be modified. In UHR (802.11bn), some PHY features are added, including 2×LDPC, unequal modulation, new MCSs, extended long range, distributed RU, and IM. The common info field and/or user info field of the EHT trigger frame may need small changes to support added features. For example, the trigger frame for UHR uplink trigger-based data transmission may reuse the legacy EHT with some slight changes. The CBF trigger may provide similar aspects to the trigger frame for UHR uplink trigger-based data transmission. There are two reserved bits in the EHT user info field as shown below in Tables 13 and 14. The reserved bits may be used to support the added UHR features. For example, bit B20 in the user info field may signal whether the legacy 1×LDPC or the added 2× lifted LDPC is used instead of signaling the legacy BCC and 1×LDPC. In another example, bits B21-B25 the user info field may signal the MCS of the CBF transmission to the user, which may be selected from the augmented MCS set that includes the new MCSs.

The trigger dependent common info subfield of the basic trigger frame may be reused for CBF as well. Each user info field includes the information for one user scheduled in the CBF data transmission. The user info fields in the EHT-SIG or UHR-SIG of the CBF data transmission are generated from the user info fields in the CBF trigger frame.

TABLE 13
EHT Trigger Frame Variant User Info Field Format:

| | | | UL FEC | UL | | | | | Trigger |
|---|---|---|---|---|---|---|---|---|---|
| | | RU | Coding | EHT- | | SS | UL Target | | Dependent |
| Field: | AID12 | Allocation | Type | MCS | Reserved | Allocation | RX Power | PS160 | Common Info |
| Bits: | B0-B11 | B12-B19 | B20 | B21-B24 | B25 | B26-B31 | B32-B38 | B39 | Variable |

TABLE 14
EHT Trigger Dependent Common Info Subfield
Format in Basic Trigger Frame:

| | MPDU MU | TID Aggregation | | |
|---|---|---|---|---|
| Field: | Spacing Factor | Limit | Reserved | Preferred AC |
| Bits: | B0-B1 | B2-B4 | B5 | B6-B7 |

The sharing and shared APs need to generate the UHR-SIG or EHT-SIG field of the data PPDU exactly the same, and the scheduled users are from two APs. One bit in the user info field (e.g., a reserved bit) may be used to indicate to which AP the user belongs. If 802.11 defines a rule to fill the user info fields of the two content channels of the UHR-SIG or EHT-SIG of the CBF transmission, then using one reserved bit may be sufficient for the signaling. For example, the corresponding user info fields may be sequentially assigned to the two content channels in a round robin fashion. Otherwise, another bit may be used to signal to which content channel the corresponding user info field is to be sent. Because the CBF transmission is downlink, bits B32-B38 in the user info field may be repurposed for the CBF indications discussed above.

The shared AP may use the CBF trigger frame to estimate the carrier frequency offset (CFO) between the sharing and shared APs. With the CFO estimate, the shared AP may compensate for the CFO in sending the CBF data PPDU. With the CFO compensation, the residual frequency mismatch should be within a few ppm (e.g., 5 ppm). Otherwise, the orthogonality among the spatial channel estimates, enabled by the P-matrix encoding over the UHR-LTF or EHT-LTF symbols, degrades significantly such that an error flood occurs for high MCSs. The frequency mismatch may be up to 40 ppm if CFO compensation is not applied.

In some embodiments, the CBF signaling fields include U-SIG, the common field of a trigger frame, and a user field of a trigger frame. Tables 15 and 16 show a proposed U-SIG signaling for CBF in which U-SIG2 can signal whether CBF is used for a current PPDU when the PPDU type field signals non-ELR PPDU type. Bit B2 in U-SIG2 may be set to 1 when CBF is applied to the current PPDU and bits B20-B25 are set to the BSS color of the other participant AP (e.g., the shared AP), and may be set to 0 otherwise, in which bits B20-B24 of U-SIG2 remain as disregard bits and bit B25 is set as validate in the EHT U-SIG.

TABLE 15
U-SIG 1 Field:

| | | | Bit 7- | Bit 13- | Bit 20- |
|---|---|---|---|---|---|
| Bit 0-Bit 2 | Bit 3-Bit 5 | Bit 6 | Bit 12 | Bit 19 | Bit 25 |
| PHY | PPDU | UL/DL | BSS | TXOP | BSS |
| Version | Bandwidth | | Color | | Color 2 |

TABLE 16
U-SIG 2 Field:

| Bit0-Bit1 | Bit2 | Bit3-Bit7 | Bit8 | Bit9-Bit10 | Bit11-Bit15 | Bit16-Bit19 | Bit20-Bit25 |
|---|---|---|---|---|---|---|---|
| PPDU | CBF Bit | Punctured | Validate | EHT-SIG | Number of | CRC | Tail |
| Type | | Channel | | MCS | EHT-SIG | | |
| | | Info | | | Symbols | | |

A variant of the design above is to use one the entry of the PPDU type field to indicate CoBF. Namely, CoBF PPDU is treated as a type of PPDU like OFDMA, MU MIMO, and non-MU MIMO. Because CoBF only works for the downlink and there are only three PPDU types in downlink for EHT, CoBF can be indicated by the fourth entry indicated by the two bits of PPDU type in UHR. If two bits for the PPDU type field is not enough, the PPDU type field may be increased to three bits.

There is a problem in the design in Tables 15 and 16 above. Because the legacy devices cannot read the second BSS color in the BSS color 2 field of a CoBF PPDU, the legacy devices with the second BSS color will treat the CoBF PPDU as OBSS PPDU and may contend for transmission. To address this issue, few designs are proposed below.

In the following design options, the field of PHY version identifier should be set to the indication of UHR or 802.11bn. The CoBF transmission may be indicated by a separate bit, e.g., B2 of U-SIG2, or an unused entry in an existing field, e.g., value 3 of PPDU Type in U-SIG2. The legacy BSS Color field in B7-B12 of USIG1 may be set to value 0 so that all 802.11be/bn devices will set the NAV properly. The BSS colors of the sharing and shared APs can be full size or partial. The indication bits of the BSS colors of the sharing and shared APs can be distributed among U-SIG field, Common field, and Use field, e.g., U-SIG field only, {U-SIG field and Common field}, {U-SIG field and User field}, or {U-SIG field, Common field, and User field}. The disregard, validate, and reserved bits in the U-SIG, Common, and User fields of EHT version are the most usable bits that can be repurposed for the additional BSS color indication. Another way to get indication bits for the BSS color indication is to reduce the length of existing field. The third way to get bits is to repurpose the bit(s) of an existing field when CoBF transmission or a parameter of the CoBF transmission is indicated. For example, when CoBF transmission is indicated, some the existing field may not be relevant for CoBF transmission and therefore the bits of the field can be reused for BSS color indication.

Option 1: Two CBF BSS colors in U-SIG. In this option, three BSS colors are signaled in U-SIG as illustrated in Tables 17 and 18. The version independent bits are B0-B19 of U-SIG1. The first BSS color, denoted as BSS color 0, is indicated by the BSS color field that is located at B7-B12 of U-SIG1 symbol. Because the BSS color 0 is located within version independent fields, the legacy 802.11be device can read it. Because the CoBF PPDU is intended for STAs of more than one BSSs, BSS color 0 should be set to 0. To indicate whether the PPDU is for CoBF, one of the version dependent bits, which are B20-B25 of U-SIG1 may be set, e.g., to 1. Once the CoBF bit is set, the remaining of the version dependent bits may be used to indicate the following fields: 1) BSS color(s), 2) Punctured Channel Information, 3) UHR-SIG MCS, and 4) Number of UHR-SIG Symbols. The locations or order of the fields within the version dependent bits have many options, which may be different from the one in Tables 17 and 18. In addition, the number of bits of each field within the version dependent bits also have many options, which may be different from the one in Tables 17 and 18. Note that the two bits of the original field “PPDU Type” in Tables 15 and 16 is repurposed in Tables 17 and 18 when the CoBF indication bit is set for indicating CoBF transmission.

TABLE 17
U-SIG 1 Field:

| Bit0-Bit2 | Bit3-Bit5 | Bit6 | Bit7-Bit12 | Bit13-Bit19 | Bit20 | Bit21-Bit25 |
|---|---|---|---|---|---|---|
| PHY | PPDU | UL/DL | BSS | TXOP | CoBF | Punctured |
| Version | Bandwidth | | Color | | | Channel |
| | | | | | | Info |

TABLE 18
U-SIG 2 Field:

| Bit 0- | Bit 6- | | Bit 13- | Bit 16- | Bit 20- |
|---|---|---|---|---|---|
| Bit 5 | Bit 11 | Bit 12 | Bit 15 | Bit 19 | Bit 25 |
| BSS | BSS | UHR-SIG | Number | CRC | Tail |
| Color 1 | Color 2 | MCS | of EHT- | | |
| | | | SIG | | |
| | | | symbols | | |

In this option, the present disclosure proposes to pack two BSS colors into the version dependent bits of U-SIG. The two BSS colors are for the sharing AP and the shared AP, respectively. For example, BSS color 1 and BSS color 2 may be for the sharing and shared APs, representing. Either of the two BSS colors can be full size or partial. The full sizes of the three fields, i.e., Punctured Channel Information, UHR-SIG MCS, and Number of UHR-SIG Symbols are shown in Tables 15 and 16, respectively. With the added BSS colors, the sizes of three fields may be reduced. For example, in Tables 17 and 18, the length of the field “Number of UHR-SIG Symbols” is reduced from 5 bits down to 3 bits for getting space for the added BSS colors because there are no more than 8 users in CoBF transmission. For another example, in Tables 17 and 18, the length of the field “UHR-SIG MCS” is reduced from 2 bits down to 1 bit. In this case, there are only up to 2 MCSs for the UHR-SIG of CoBF PPDU. Because CoBF has higher gain when the STA is close to its AP, the two MCSs may be MCS 1 and MCS 3.

Option 2: BSS color 2 partially offloaded to common field. In some designs, it may be desirable not to reduce the length too much or at all, or to repurpose the field “PPDU Type.” In these cases, the length of the added BSS color may be reduced, i.e., using partial BSS color or shift some of the BSS color bits to the subsequent common field or use field of UHR-SIG. An example is shown in Tables 19-21. In this example, parts of BSS Color 2 are in U-SIG and the last part of BSS Color 2 is in the common field. The CoBF transmission is indicated by value 3 of PPDU Type field. The field, Number of UHR-SIG Symbols, is shortened to 4 bits saving one bit for the indication of BSS Color 2. In the common field, the disregard bits in B13-B15 of EHT U-SIG2 may be repurposed for indicating BSS Color 2 in UHR when CoBF transmission is indicated. As alternative bits for BSS color indication, the 4 bits of Spatial Reuse field, 1 bit of GI+LTF Size field, 1 more bit in Number of UHR-SIG Symbols field, 1 bit of Number of Non-OFDMA Users field, and 1 bit of Number of UHR-LTF Symbols field in Tables 19-21 can be repurposed for BSS color indication when CoBF is indicated. For example, in the common field, because 0.8 us GI may not be enough for aligning the multi-AP transmissions, the 0.8 us GI schemes may not be used for CoBF, the field, GI+LTF Size, so that the field may be shortened to 1 bit saving one bit for the indication of BSS Color 2.

TABLE 19
U-SIG 1 Field:

| Bit 0- | | | Bit 7- | Bit 13- | |
|---|---|---|---|---|---|
| Bit 2 | Bit 3-Bit 5 | Bit 6 | Bit 12 | Bit 19 | Bit 20-Bit 25 |
| PHY | PPDU | UL/DL | BSS | TXOP | BSS Color 1 |
| Version | BW | | Color 0 | | |
| Identifier | | | | | |

TABLE 20
U-SIG 2 Field:

| Bit0-Bit1 | Bit2 | Bit3-Bit7 | Bit8 | Bit9-Bit10 | Bit11 | Bit12-Bit15 | Bit16-Bit19 | Bit20-Bit25 |
|---|---|---|---|---|---|---|---|---|
| PPDU | Part 1 | Punctured | Part 2 | UHR-SIG | Part 3 | Number of | CRC | Tail |
| Type | of BSS | Channel | of BSS | MCS | of BSS | UHR-SIG | | |
| | Color 2 | Info | Color 2 | | Color 2 | Symbols | | |

TABLE 21
Common Field of Non-OFDMA Transmission:

| Bit0-Bit3 | Bit4-Bit5 | Bit6-Bit8 | Bit9 | Bit10-Bit11 | Bit12 | Bit13-Bit15 | Bit16-Bit18 |
|---|---|---|---|---|---|---|---|
| Spatial | GI + LTF | Number of | LDPC Extra | Pre-FEC | PE | Part 4 | Number of |
| Reuse | Size | UHR-LTF | Symbol | Padding | Disambiguity | of BSS | non-OFDMA |
| | | Symbols | Segment | Factor | | Color 2 | Users |

Another example signaling of CBF is shown in Tables 22-24 in which parts of BSS color 2 are signaled in U-SIG reusing validate bits of EHT-SIG and the last part of BSS color 2 being included in the common field. The CBF transmission is signaled by a value of 3 in the PPDU type field. Because CBF is a type of spatial reuse and because spatial reuse other than the shared AP should be avoided to reduce interference, the spatial reuse field in EHT may be repurposed for the BSS color signaling when a CBF transmission is signaled.

TABLE 22
U-SIG 1 Field:

| Bit 0- | | | Bit 7- | Bit 13- | |
|---|---|---|---|---|---|
| Bit 2 | Bit 3-Bit 5 | Bit 6 | Bit 12 | Bit 19 | Bit 20-Bit 25 |
| PHY | PPDU | UL/DL | BSS | TXOP | BSS Color 1 |
| Version | BW | | Color 0 | | |
| Identifier | | | | | |

TABLE 23
U-SIG 2 Field:

| Bit0-Bit1 | Bit2 | Bit3-Bit7 | Bit8 | Bit9-Bit10 | Bit11-Bit15 | Bit16-Bit19 | Bit20-Bit25 |
|---|---|---|---|---|---|---|---|
| PPDU | Part 1 | Punctured | Part 2 | UHR-SIG | Number of | CRC | Tail |
| Type | of BSS | Channel | of BSS | MCS | UHR-SIG | | |
| | Color 2 | Info | Color 2 | | Symbols | | |

TABLE 24
Common Field of Non-OFDMA Transmission:

| Bit0-Bit3 | Bit4-Bit5 | Bit6-Bit8 | Bit9 | Bit10-Bit11 | Bit12 | Bit13-Bit15 | Bit16-Bit18 |
|---|---|---|---|---|---|---|---|
| Part 3 | GI + LTF | Number of | LDPC Extra | Pre-FEC | PE | Disregard | Number of |
| of BSS | Size | UHR-LTF | Symbol | Padding | Disambiguity | | non-OFDMA |
| Color 2 | | Symbols | Segment | Factor | | | Users |

Another example of CBF signaling is shown in Tables 25-27 in which BSS color 1 is signaled in U-SIG and BSS color 2 is signaled in the common field. The CBF transmission is signaled by B2 of U-SIG2, or by value 3 of the PPDU type field. Because CBF is a type of spatial reuse and because spatial reuse other than the shared AP should be avoided to reduce interference, the spatial reuse field in EHT may be repurposed for the BSS color signaling when a CBF transmission is signaled. For simplicity, only one GI+LTF size (e.g., 2×LTF+1.6 us) is used for CBF, and as a result, there is no need to signal the GI+LTF size, so B4-B5 of the common field may be used to signal the BSS color.

TABLE 25
U-SIG 1 Field:

| Bit 0- | | | Bit 7- | Bit 13- | |
|---|---|---|---|---|---|
| Bit 2 | Bit 3-Bit 5 | Bit 6 | Bit 12 | Bit 19 | Bit 20-Bit 25 |
| PHY | PPDU | UL/DL | BSS | TXOP | BSS Color 1 |
| Version | BW | | Color 0 | | |
| Identifier | | | | | |

TABLE 26
U-SIG 2 Field:

| Bit0-Bit1 | Bit2 | Bit3-Bit7 | Bit8 | Bit9-Bit10 | Bit11-Bit15 | Bit16-Bit19 | Bit20-Bit25 |
|---|---|---|---|---|---|---|---|
| PPDU | CBF | Punctured | Validate | UHR-SIG | Number of | CRC | Tail |
| Type | indication | Channel | | MCS | UHR-SIG | | |
| | is set | Info | | | Symbols | | |

TABLE 27
Common Field of Non-OFDMA Transmission:

| Bit0-Bit5 | Bit6-Bit8 | Bit9 | Bit10-Bit11 | Bit12 | Bit13-Bit15 | Bit16-Bit18 |
|---|---|---|---|---|---|---|
| BSS | Number of | LDPC Extra | Pre-FEC | PE | Disregard | Number of |
| Color 2 | UHR-LTF | Symbol | Padding | Disambiguity | | non-OFDMA |
| | Symbols | Segment | Factor | | | Users |

Option 3: BSS color 2 entirely offloaded to common field. The entire indication of BSS color 2 may be offloaded to the common field as illustrated in Tables 28-31. The CoBF indication can be in B2 of U-SIG1 or unused value, e.g., value 3 of PPDU Type. Because CoBF is a kind of spatial reuse and spatial reuse other than the shared AP should be avoided, the Spatial Reuse field in EHT may be repurposed for BSS color indication when CoBF transmission is indicated. In Tables 28-31, B0-B3 of U-SIG2 are used for indicating the first part of BSS Color 2. The remaining two bits of BSS Color 2 may be indicated by two of the EHT disregard bits in U-SIG2, e.g., B13-B14. Note that the bit number of the common field in UHR may not be the same as EHT. For example, the number for UHR may be one or two bits less than EHT. To shorten the common field, the initial disregard bits are removed first and the subsequential fields are shifted accordingly. Therefore, there may be no disregard bit in UHR common field with the added BSS color indication. Namely, the Part 2 of BSS Color 2 may be followed immediately by the Number of Non-OFDMA Users. Note, to simplify the information sharing between two APs, a fixed a factor value such as a=4 should be used for CoBF transmission.

TABLE 28
U-SIG 1 Field:

| Bit 0- | | | Bit 7- | Bit 13- | |
|---|---|---|---|---|---|
| Bit 2 | Bit 3-Bit 5 | Bit 6 | Bit 12 | Bit 19 | Bit 20-Bit 25 |
| PHY | PPDU | UL/DL | BSS | TXOP | BSS Color 1 |
| Version | BW | | Color 0 | | |
| Identifier | | | | | |

TABLE 29
U-SIG 2 Field:

| Bit0-Bit1 | Bit2 | Bit3-Bit7 | Bit8 | Bit9-Bit10 | Bit11-Bit15 | Bit16-Bit19 | Bit20-Bit25 |
|---|---|---|---|---|---|---|---|
| PPDU | CBF | Punctured | Validate | UHR-SIG | Number of | CRC | Tail |
| Type = | indication | Channel | | MCS | UHR-SIG | | |
| non ELR | is set | Info | | | Symbols | | |

TABLE 30
Common Field of Non-OFDMA Transmission:

| Bit0-Bit3 | Bit4-Bit5 | Bit6-Bit8 | Bit9 | Bit10-Bit11 | Bit12 | Bit13-Bit14 | Bit15 | Bit16-Bit18 |
|---|---|---|---|---|---|---|---|---|
| Part 1 | GI + LTF | Number of | LDPC Extra | Pre-FEC | PE | Part 2 | Disregard | Number of |
| of BSS | Size | UHR-LTF | Symbol | Padding | Disambiguity | of BSS | | non-OFDMA |
| Color 2 | | Symbols | Segment | Factor | | Color 2 | | Users |

TABLE 31
Common Field of Non-OFDMA Transmission (Alternative to Table 30 for use with Tables 28 and 29):

| Bit0-Bit3 | Bit4-Bit5 | Bit6-Bit8 | Bit9 | Bit10-Bit11 | Bit12 | Bit13-Bit14 | Bit15 | Bit16-Bit18 |
|---|---|---|---|---|---|---|---|---|
| Part 1 | GI + LTF | Number of | LDPC Extra | Part 2 | PE | Starting | IM | Number of |
| of BSS | Size | UHR-LTF | Symbol | of BSS | Disambiguity | User Index | | non-OFDMA |
| Color 2 | | Symbols | Segment | Color 2 | | in 2^{nd} BSS | | Users |

Option 4: BSS colors in the special user field. In this option, the CoBF indication is in the U-SIG. For example, one of the disregard or validate bits in EHT-SIG, e.g., B20-B25 of U-SIG1, B2/B8 of U-SIG2, and one of the unused entries in EHT U-SIG like value 3 of PPDU Type can be reused as the indication bit of UHR CoBF. In the design example in Tables 32-35, B25 of U-SIG1 is used as the indication bit of UHR CoBF. When the CoBF indication is set to indicate CoBF transmission, a special user field is included in UHR-SIG. The special user field carries a special STA-ID like 2007, which is defined in the spec and is not assigned to any user. The user field with the special STA-ID carries the BSS colors of the sharing and shared APs. The length of the special user field may be the same as regular user field, e.g., 23 bits or 24 bits. If the length of user field is 24 bits, one validate or disregard or reserved bit may be included in the special user field. The special user field may be the first (or the last) user field in the sequence of user fields, which follow the common field. If the special user field is the first in the user field sequence, the common field and the special user field may be encoded in one BCC codeword sharing one CRC and one set of tail bits.

TABLE 32
U-SIG 1 Field:

| Bit0-Bit2 | Bit3-Bit5 | Bit6 | Bit7-Bit12 | Bit13-Bit19 | Bit20-Bit24 | Bit25 |
|---|---|---|---|---|---|---|
| PHY | PPDU | UL/DL | BSS | TXOP | Disregard | CBF |
| Version | BW | | Color 0 | | | Indication |
| Identifier | | | | | | Set |

TABLE 33
U-SIG 2 Field:

| Bit0-Bit1 | Bit2 | Bit3-Bit7 | Bit8 | Bit9-Bit10 | Bit11-Bit15 | Bit16-Bit19 | Bit20-Bit25 |
|---|---|---|---|---|---|---|---|
| PPDU | CBF | Punctured | Validate | UHR-SIG | Number of | CRC | Tail |
| Type | indication | Channel | | MCS | UHR-SIG | | |
| | is set | Info | | | Symbols | | |

TABLE 34
Common Field of Non-OFDMA Transmission:

| Bit0-Bit3 | Bit4-Bit5 | Bit6-Bit8 | Bit9 | Bit10-Bit11 | Bit12 | Bit13-Bit15 | Bit16-Bit18 |
|---|---|---|---|---|---|---|---|
| Spatial | GI + LTF | Number of | LDPC Extra | Pre-FEC | PE | Disregard | Number of |
| Reuse | Size | UHR-LTF | Symbol | Padding | Disambiguity | | non-OFDMA |
| | | Symbols | Segment | Factor | | | Users |

TABLE 35
Special User Field:

| Bit 0- | Bit 11- | |
|---|---|---|
| Bit 10 | Bit 16 | Bit 17-Bit 22 |
| Special | BSS | BSS Color 2 |
| STA- | Color 1 | |
| ID | | |

Option 5: One BSS color in special user field. In this option the BSS Color of sharing AP can be signaled in U-SIG and the BSS Color of the shared AP can be signaled in the Special User field in UHR-SIG. As a result, STAs associated to the sharing AP can mark the CoBF PPDU correctly as an intra-BSS PPDU.

Option 6: Dedicated BSS color and STA-ID for CBF. In this option, the sharing AP and shared AP(s) form a CoBF group or a CoBF BSS, and a distinct BSS color, a CoBF BSS color, is assigned to the CoBF group. For each CoBF group, a distinct STA-ID is assigned to each STA that is served by the CoBF group. In CoBF transmission, the BSS color in the version independent field, i.e., B7-B12 of U-SIG1 is set to the BSS color assigned the CoBF group. The STA-ID in the user field is set to the STA-ID assigned to the STA for receiving CoBF PPDU from the CoBF group. For identifying an intra-BSS PPDU, each STA needs to check whether the BSS color in U-SIG matches with its AP's legacy BSS color and the CoBF BSS color(s) whose corresponding CoBF group(s) the STA (or its AP) participates. Similarly, for identifying an intended PPDU, each STA needs to check whether the STA-ID in the user field matches with its legacy STA-ID for non-CoBF transmissions and the STA-ID(s) that is assigned for receiving CoBF PPDUs from the CoBF groups in which the STA (or its AP) participates.

To address the EMLSR issue during CBF transmission, there are multiple options described below.

EMLSR Option 1: Each of the sharing and shared AP separately signal the ICF+ICR to their respective associated STAs after the CoBF Invite+Response exchange and before the CoBF sequence.

EMSLR Option 2: Each of the sharing and shared AP send a joint ICF message (e.g., a BSRP TF that jointly addresses the respective associated STAs) after the CoBF message and collect ICR before the DL CoBF PPDU containing data is sent. This approach requires sharing and shared AP to know the TX config and AID of the associated STAs to target as well as assign them separate AID. As such this approach is more complex than EMLSR Option 1 but preserves the basic EMLSR sequence otherwise.

For the sequence under EMLSR option 1 above, the EMLSR STAs wait until at least the CoBF Sync PPDU is received before going to listen mode. There may be multiple ways to achieve this: (1) specify a bit in ICF indicating this is a CBF sequence in which case the STAs will always wait to hear the next PPDU from AP-1 (ideally the Sync PPDU and in error case, some other PPDU from AP-1). (2) Treat the ICF from AP-2 as an intra-BSS PPDU addressed to itself and wait until the end of that ICF+ICR. Note: duration of ICR known from ICF. (3) Wait until some specified time period after a bit in ICF signals this is a CBF sequence. This may be signaled during association or set to some fixed number in spec or added to some field in the ICF (e.g., in a Special User Info field if BSRP TF are used).

For the sequence under EMLSR Option 1 above to prevent STAs associated to AP-2 from attempting NPCA during the CBF Invite/Response sequence, one or more of the following approaches may be used depending on the Invite/Response frame design: (1) the STAs treat it as intra-BSS PPDU by having the Response frame sent in non-TB PPDU with TA as AP-2's address. The Invite frame could also be unicast and contain the AP-2's MAC address in RA. The Invite/Response could be a Ctrl frame sequence (e.g., BSRP+MSTA BA) or some other sequence. (2) Set the Duration field in Invite to just protect until the following ICF so that there is not enough time to do NPCA.

To allow STAs associated to AP-2 respond to ICF, there are few options: Option 1: Duration field in ICF from AP-1 is set to protect only until the ICF sent from AP-2. Option 2: ICF from AP-2 has CS Required bit set to 0 regardless of length of the response TB PPDU.

To avoid overprotection, (1) the DL CBF PPDU (and the ones before it) shall not set NAV around shared AP-2 beyond the duration of the corresponding BA (or in case of sequential BAs until the end of the BA sequence). That is, set the TXOP field in the preamble of the DL CBF PPDU only until that time. (2) The ICF from AP-2 shall not set NAV beyond the DL CBF PPDU start in case of error (no ICR from AP2's BSS, no Sync PPDU etc.).

The above descriptions are for purposes of illustration and are not meant to be limiting. Numerous other examples, configurations, processes, algorithms, etc., may exist, some of which are described in greater detail below. Example embodiments will now be described with reference to the accompanying figures.

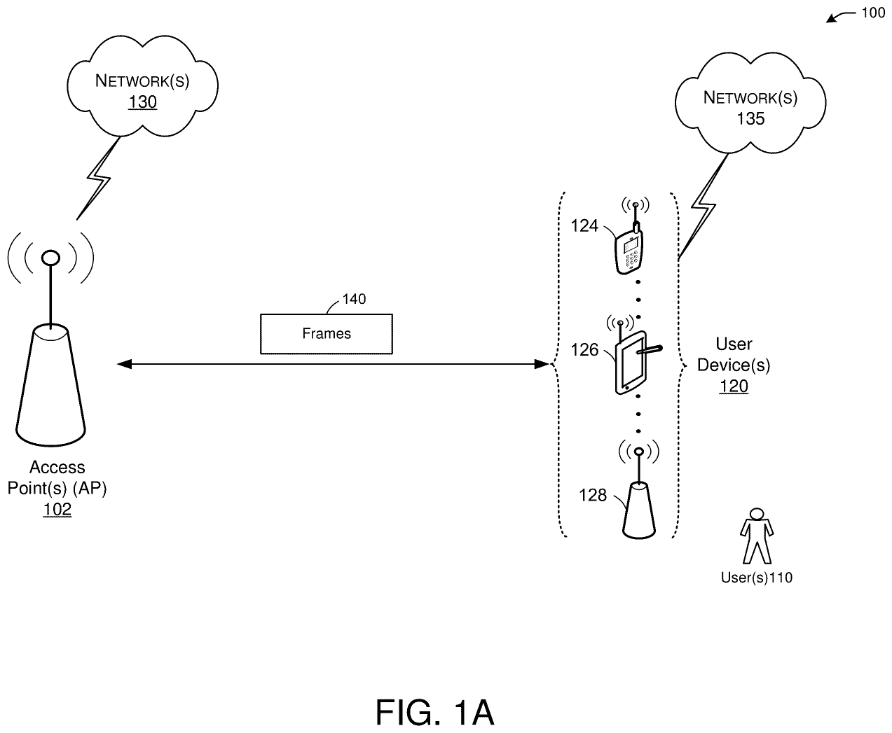

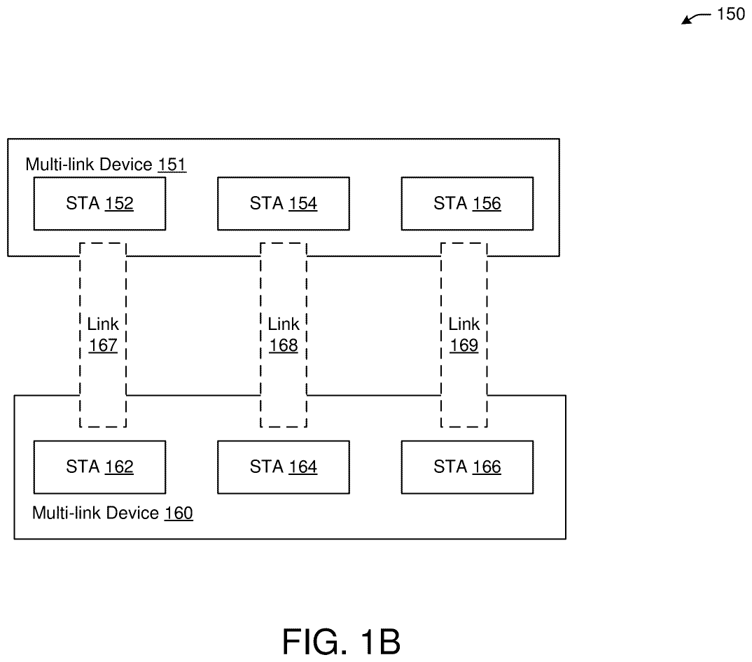

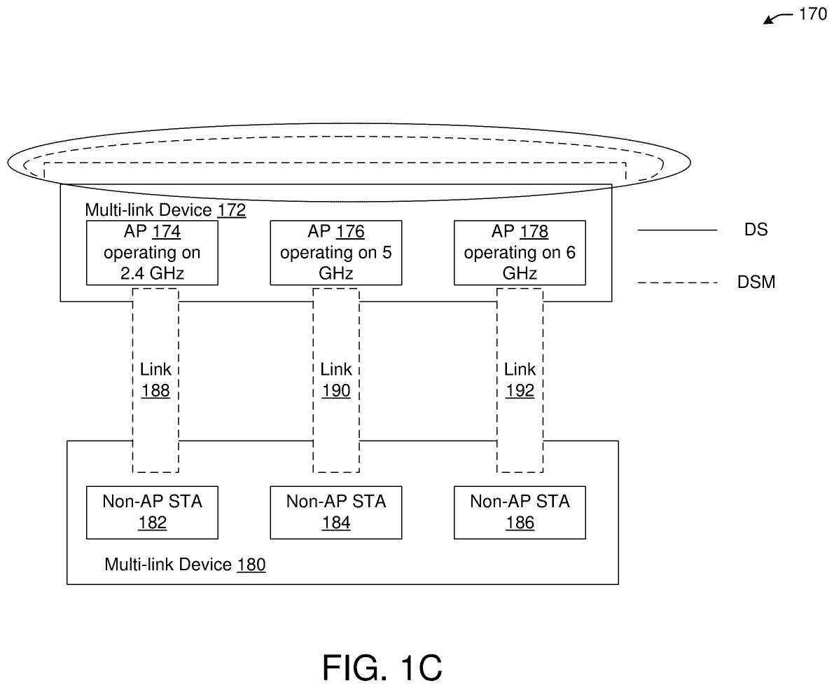

FIG. 1A is a network diagram illustrating an example network environment, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

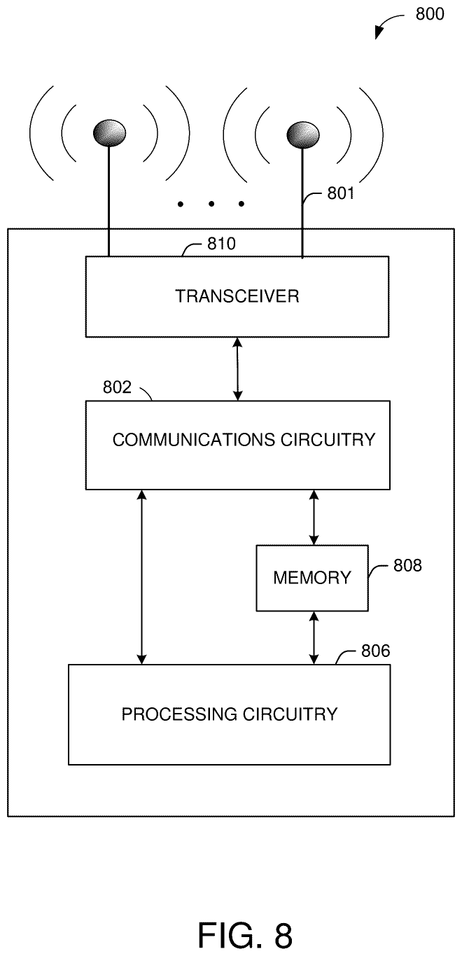

In some embodiments, the user devices 120 and the AP 102 may include one or more computer systems similar to that of the functional diagram of FIG. 8 and/or the example machine/system of FIG. 9.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QOS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IOT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IOT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, etc.), 6 GHz channels (e.g., 802.11ax, 802.11be, etc.), or 60 GHZ channels (e.g. 802.11ad, 802.11ay). 800 MHZ channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1A, a user device 120 may be in communication with one or more APs 102. For example, one or more APs 102 may exchange frames 140 with one or more user devices 120. The frames 140 may include any frames associated with CBF, including CBF signaling and data transmissions, EMLSR transmissions, and the like as described herein.

It is understood that the above descriptions are for purposes of illustration and are not meant to be limiting.

FIG. 1B depicts an illustrative schematic diagram 150 for MLD communications between two logical entities, in accordance with one or more example embodiments of the present disclosure.

Referring to FIG. 1B, there are shown two MLDs in communication with each other. MLD 151 may include multiple STAs (e.g., STA 152, STA 154, STA 156, etc.), and MLD 160 may include multiple STAs (e.g., STA 162, STA 164, STA 166, etc.). The STAs of the MLD 151 and the STAs of the MLD 160 may set up links with each other (e.g., link 167 for a first frequency band used by the STA 152 and the STA 162, link 168 for a second frequency band used by the STA 154 and the STA 164, link 169 for a second frequency band used by the STA 156 and the STA 166). In this example of FIG. 1B, the two MLDs may be two separate physical devices, where each one comprises a number of virtual or logical devices (e.g., the STAs).

FIG. 1C depicts an illustrative schematic diagram 170 for MLD communications between an AP MLD with logical entities and a non-AP MLD with logical entities, in accordance with one or more example embodiments of the present disclosure.

Referring to FIG. 1C, there are shown two MLDs on either side, each which includes multiple STAs that can set up links with each other. For infrastructure framework, MLD 172 may be an A-MLD with logical APs (e.g., AP 174, AP 176, and AP 178) on one side, and MLD 180 may be a non-AP MLD including non-AP logical entities (non-AP STA 182, non-AP STA 184, and non-AP STA 186) on the other side. The detailed definition is shown below. It should be noted that the term MLLE and MLD are interchangeable and indicate the same type of entity. Throughout this disclosure, MLLE may be used but anywhere the MLLE term is used, it can be replaced with MLD. Multi-link non-AP logical entity (non-AP MLLE, also can be referred to as non-AP MLD): A multi-link logical entity, where each STA within the multi-link logical entity is a non-AP EHT STA. it should be noted that this framework is a natural extension from the one link operation between two STAs, which are AP and non-AP STA under the infrastructure framework (e.g., when an AP is used as a medium for communication between STAs).

In the example of FIG. 1C, the MLD 172 and the MLD 180 may be two separate physical devices, where each one comprises a number of virtual or logical devices. For example, the multi-link AP logical entity may comprise three APs, AP 174 operating on 2.4 GHZ (e.g., link 188), AP 176 operating on 5 GHZ (e.g., link 190), and AP 178 operating on 6 GHZ (e.g., link 192). Further, the multi-link non-AP logical entity may comprise three non-AP STAs, non-AP STA 182 communicating with AP 174 on link 188, non-AP STA 184 communicating with AP 176 on link 190, and non-AP STA 186 communicating with AP 178 on link 192.

The MLD 172 is shown in FIG. 1C to have access to a distribution system (DS), which is a system used to interconnect a set of BSSs to create an extended service set (ESS). The MLD 172 is also shown in FIG. 1C to have access a distribution system medium (DSM), which is the medium used by a DS for BSS interconnections. Simply put, DS and DSM allow the AP to communicate with different BSSs.

It should be understood that although the example shows three logical entities within the MLD 172 and the three logical entities within the MLD 180, this is merely for illustration purposes and that other numbers of logical entities with each of the MLDs may be envisioned.

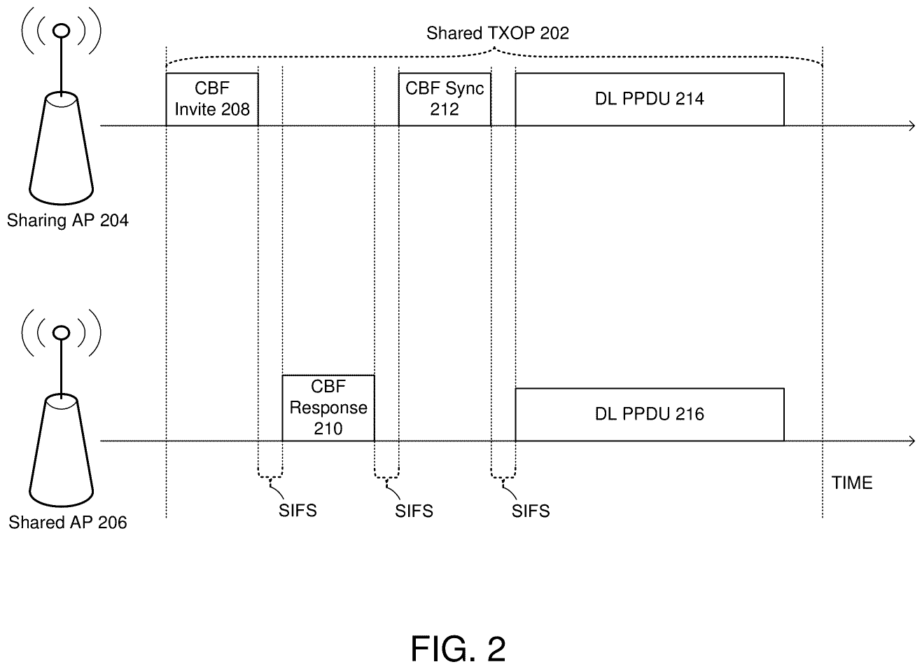

FIG. 2 shows an example CBF sequence, in accordance with one or more example embodiments of the present disclosure.

Referring to FIG. 2, during a TXOP 202 for a sharing AP 204 and a shared AP 206, the sharing AP 204 may send a CoBF invite frame 208. After SIFS or another time period, the shared AP 206 may send a CoBF response frame 210 in response to the CoBF invite frame 208. After another SIFS or another time period, the sharing AP 204 may send a CoBF sync frame 212 (e.g., to synchronize their clocks for subsequent transmissions). After another SIFS or another time period, the sharing AP 204 may send a DL PPDU 214 and the shared AP 206 may send a DL PPDU 216. The CoBF sync frame 212 may represent a confirmation message before the APs send the DL PPDU 214 to their respective associated STAs.

To address the EMLSR issue during CBF transmission, there are multiple options described below.

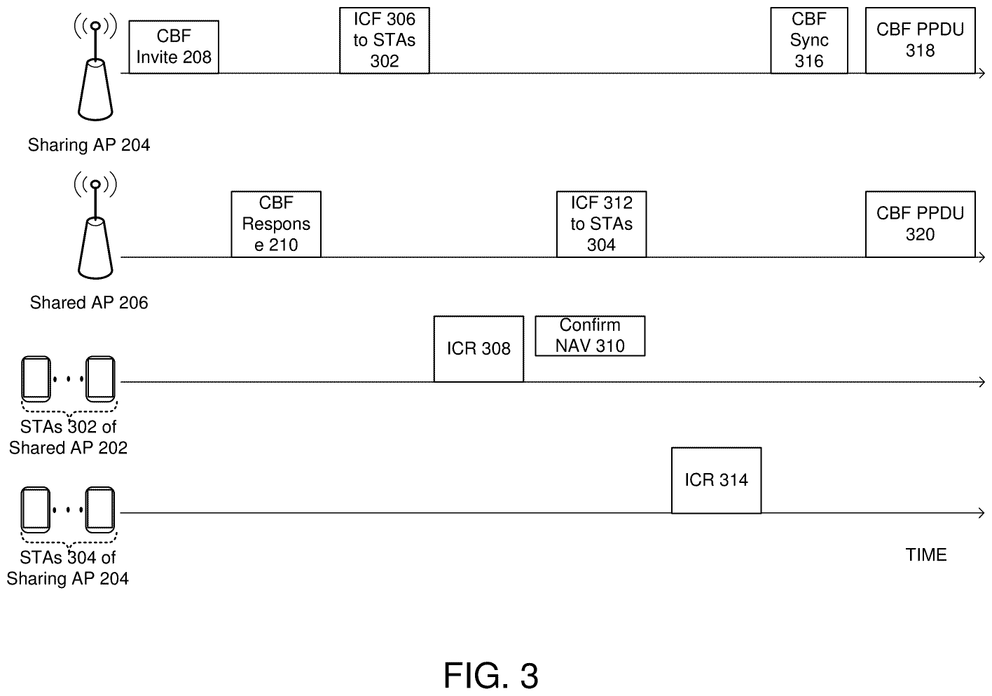

EMLSR Option 1: Each of the sharing and shared AP separately signal the ICF+ICR to their respective associated STAs after the CoBF Invite+Response exchange and before the CoBF sequence. FIG. 3 shows this example sequence.

FIG. 3 shows an example CBF sequence, in accordance with one or more example embodiments of the present disclosure. FIG. 3 represents EMLSR option 1 above in which each of the sharing and shared AP separately signal the ICF+ICR to their respective associated STAs after the CoBF Invite+Response exchange and before the CoBF sequence.

Referring to FIG. 3, there may be STAs 302 associated to the sharing AP 204, and STAs 304 associated to the shared AP 206. The sharing AP 204 may send the CBF invite frame 208, and the shared AP 206 may respond with the CBF response frame 210. The sharing AP 204 may send an ICF 306 to the STAs 302, which may respond with an ICR 308 and then may confirm their NAVs at step 310. The shared AP 206 may send an ICF 312 to the STAs 304, which may respond with an ICR 314. Then, the sharing AP 204 may send a CBF sync 316, and the sharing AP 204 may send a CBF PPDU 318 to the STAs 302 and the shared AP 206 may send a CBF PPDU 320 to the STAs 304.

In an alternative option, the sharing AP 204 and the shared AP 206 may send a joint ICF and collect the ICRs from the associated STAs before sending the CBF PPDUs 318 and 320.

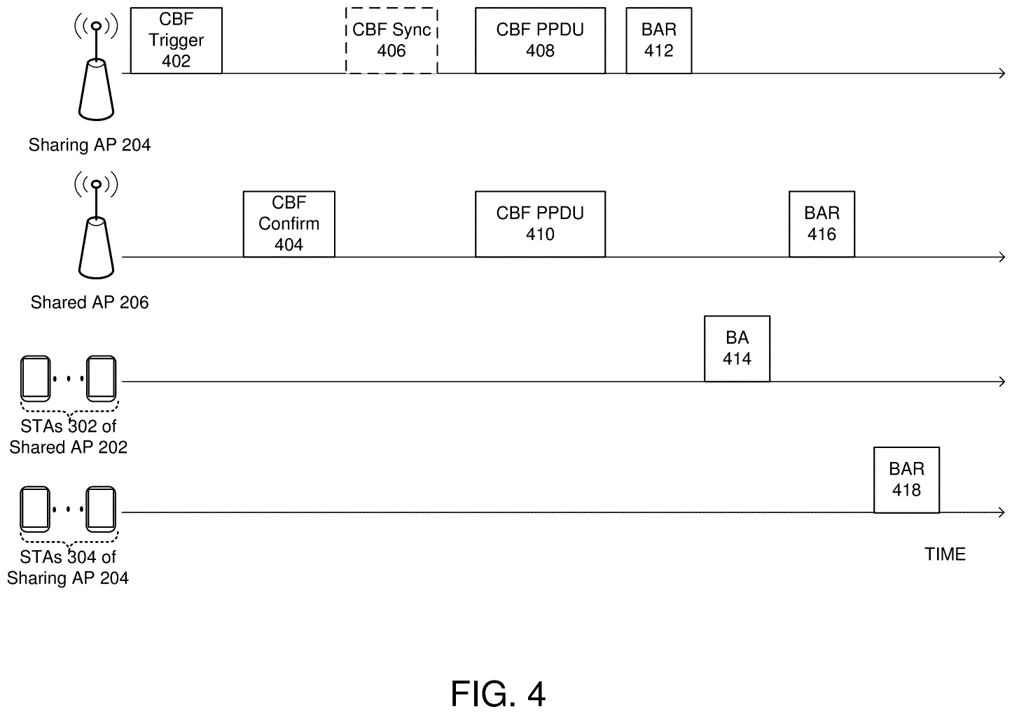

FIG. 4 shows an example CBF sequence, in accordance with one or more example embodiments of the present disclosure.

Referring to FIG. 4, the sharing AP 204 may send (during a transmission phase) a CBF trigger frame 402, and the shared AP 206 may respond with a CBF confirm frame 404. Optionally, the sharing AP 204 may send a sync frame 406, after which the sharing AP 204 and the shared AP 206 may send synchronized CBF transmissions (e.g., CBF PPDU 408 and CBF PPDU 410). The APs and their associated STAs (e.g., the STAs 302 associated to the sharing AP 204 and the STAs 304 associated to the shared AP 206) each may send block acknowledgements to the CBF transmissions (e.g., the sharing AP 204 may send BA 412 to the STAs 302, which may respond with a BAR 414, and the shared AP 206 may send a BAR 416 to the STAs 304, which may respond with a BA 418).

The CBF trigger frame 402 may include PPDU (mainly a preamble) parameters for aligning the CBF transmissions 408 and 410 and also may include a final stream allocation in sharing a BSS of the AP 204. The CBF confirm frame 404 may act as an acknowledgement of the CBF trigger frame 402, using the PPDU parameters and providing a final stream allocation in sharing a BSS of the AP 204.

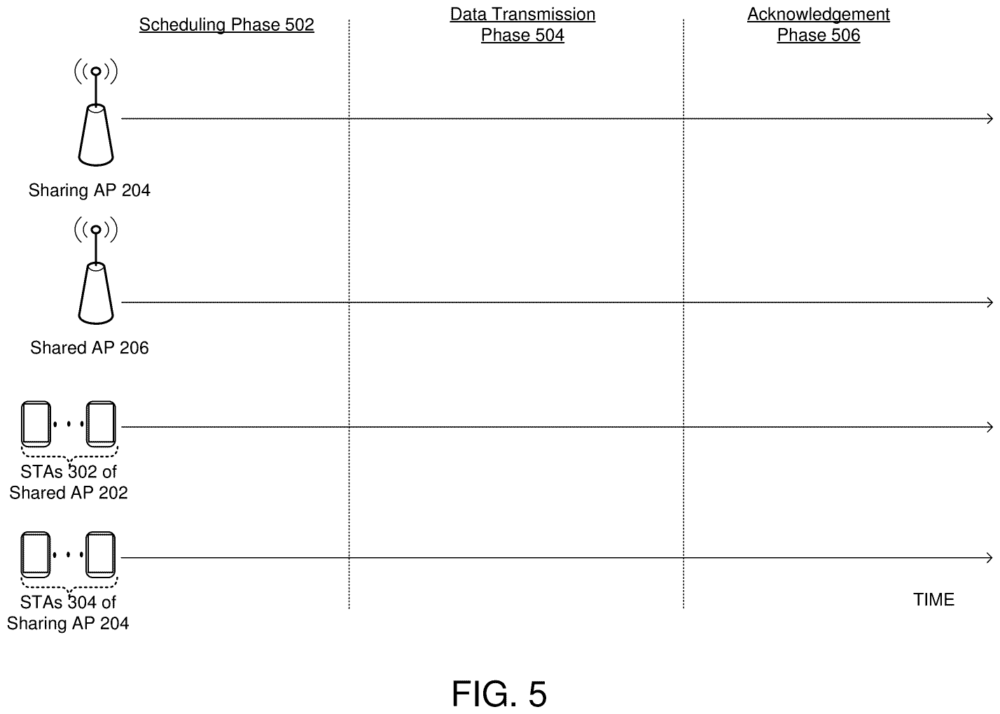

FIG. 5 shows an example CBF data transmission with three phases, in accordance with one or more example embodiments of the present disclosure.

Referring to FIG. 5, the three phases of the CBF data transmission may include a scheduling phase 502, a data transmission phase 504, and an acknowledgment phase 506. Preceding the scheduling phase 502 may be a channel training phase (not shown) as described above.

Before the CBF scheduling phase 502 is a channel training phase (not shown). After the channel training phase, the CBF APs 202 and 204 receive vectors or matrices for beamforming and nulling used in the data transmission phase 504. In the scheduling phase 502, the APs 202 and 204 may exchange the buffer status of the candidate users 302 and 304. The sharing AP 204 may send the shared AP 206 the following during the scheduling phase: (1) The AIDs of the users of the sharing AP and that have buffered data at the sharing AP (e.g., the AIDs of the STAs to receive the subsequent CBF data transmission). (2) The AIDs of the users of the shared AP and whose nulling vectors are available at the sharing AP. (3) The buffer status of the users in (1) (e.g., queue size and/or access category). (4) Restrictions on the user grouping imposed by the sharing AP. Similarly, the shared AP may send the following to the sharing AP: (5) The AIDs of the users of the shared AP and who have buffered data at the shared AP. (6) The AIDs of the users of the sharing AP and whose nulling vectors are available at the shared AP. (7) The buffer status of the users in (5) (e.g., queue size and/or access category). (8) Restrictions on the user grouping imposed by the shared AP.

Because the desired user and the OBSS user may be in similar directions, the APs may not be able to perform beamforming to the desired user while doing the nulling to the OBSS user. Therefore, there may be some restrictions in grouping the users across BSSs. The APs 202 and 204 may exchange lists of incompatible users for the user grouping. Besides the user scheduling, the AP may wake up users during scheduling phase. For example, an AP may send an ICF to a power-save user (e.g., an STA in a power save mode), which may use ELMSR, to move the user's reception capability from low to high. The user may respond to the ICF by an ICR acknowledging the request.

In one or more embodiments, in the data transmission phase 504 after the scheduling phase 502, the sharing AP 204 and the shared AP 206 may conduct one data transmission phase and one acknowledgement phase, or the two APs may repeat the data transmission phase 504 and acknowledge phase 506 for multiple times. There are multiple options for the data transmission phase 504. In one option, the data transmission phase 504 consists of CBF trigger, confirmation, synch frame, and CBF transmission. In another option, ELMSR is used. The AP needs to bring the user from low capability mode to high capability mode. In some options, the trigger immediately precedes CBF data transmission. For the data bursts after the first within the TXOP for the same group of users, ICF and ICR may not be sent before the CBF data transmission because the users already brought up the reception capabilities by the initial ICF/ICR.

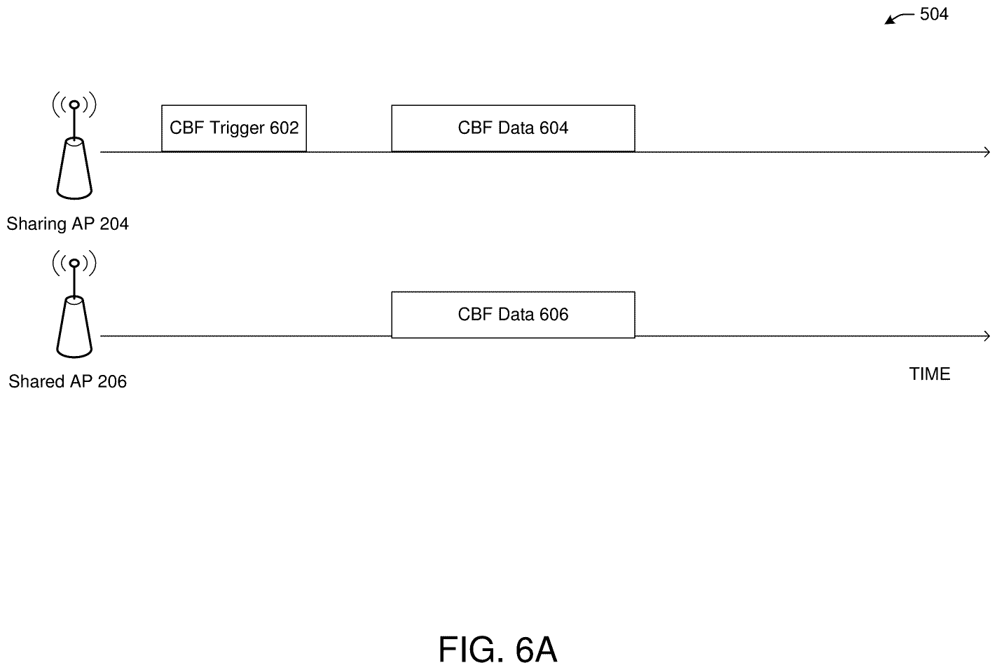

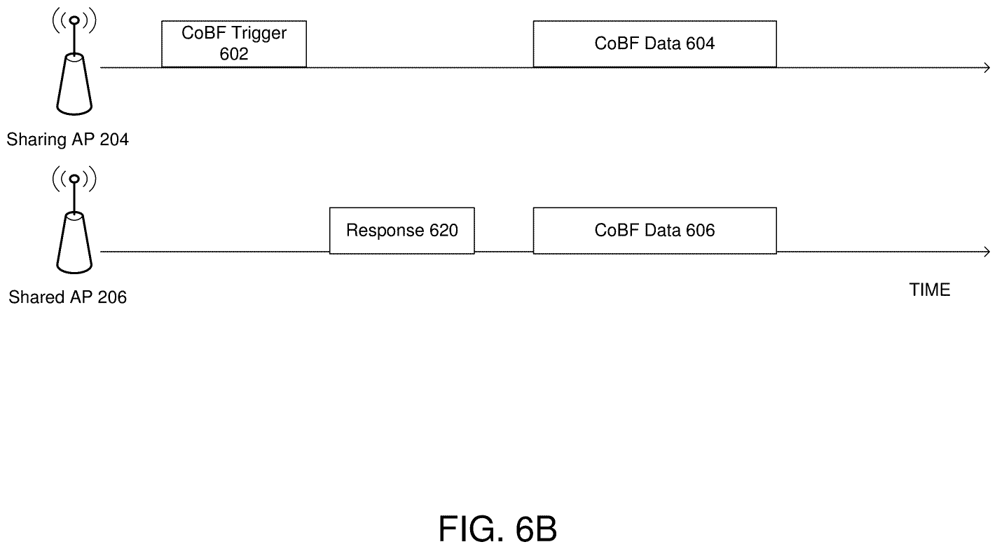

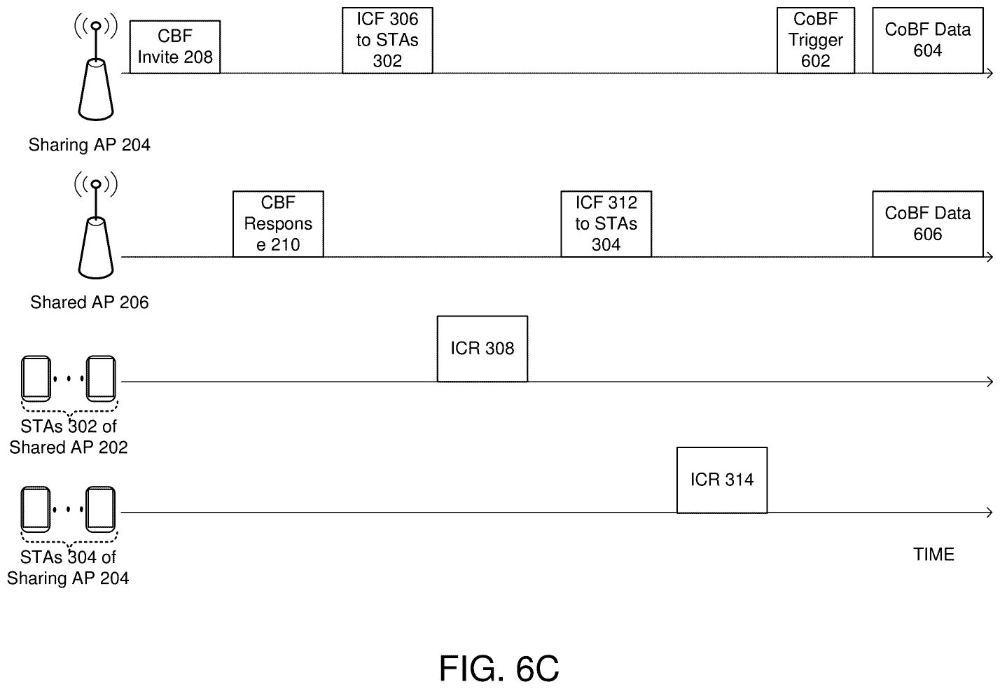

FIG. 6A shows one option for the data transmission phase 504 of FIG. 5, in accordance with one or more embodiments of the present disclosure.

Referring to FIG. 6A, the sharing AP 204 may send a CBF trigger frame 602, and then the sharing AP 204 may send CBF data 604 and the shared AP 206 may send CBF data 606.

FIG. 6B shows one option for the data transmission phase 504 of FIG. 5, in accordance with one or more embodiments of the present disclosure.

Referring to FIG. 6B, the, the sharing AP 204 may send the CBF trigger frame 602, and then the sharing AP 204 may respond with a response frame 620. Then the sharing AP 204 may send CBF data 604 and the shared AP 206 may send CBF data 606.

FIG. 6C shows one option for the data transmission phase 504 of FIG. 5, in accordance with one or more embodiments of the present disclosure. The option in FIG. 6C uses ELMSR.

Referring to FIG. 6C, the, the sharing AP 204 may send the CBF invite 208 and the shared AP 206 may respond with the CBF response 210. The sharing AP 204 may send the ICF 306 to the STAs 302, which may respond with the ICR 308. The shared AP 206 may send the ICF 312 to the STAs 304, which may respond with the ICR 314. Then the sharing AP 204 may send the CBF trigger frame 602, which may precede the sharing AP 204 sending the CBF data 604 and the shared AP 206 sending the CBF data 606.

Referring to FIGS. 6A-6C, the CBF trigger frame 602 may immediately precede the CBF data transmissions 604 and 606. For data bursts after the first one within the TXOP for a same group of STA users, the ICF and ICR in FIG. 6C may not be sent before the CBF data transmissions because the SA users have increased their reception capabilities due to the ICF/ICR exchange.

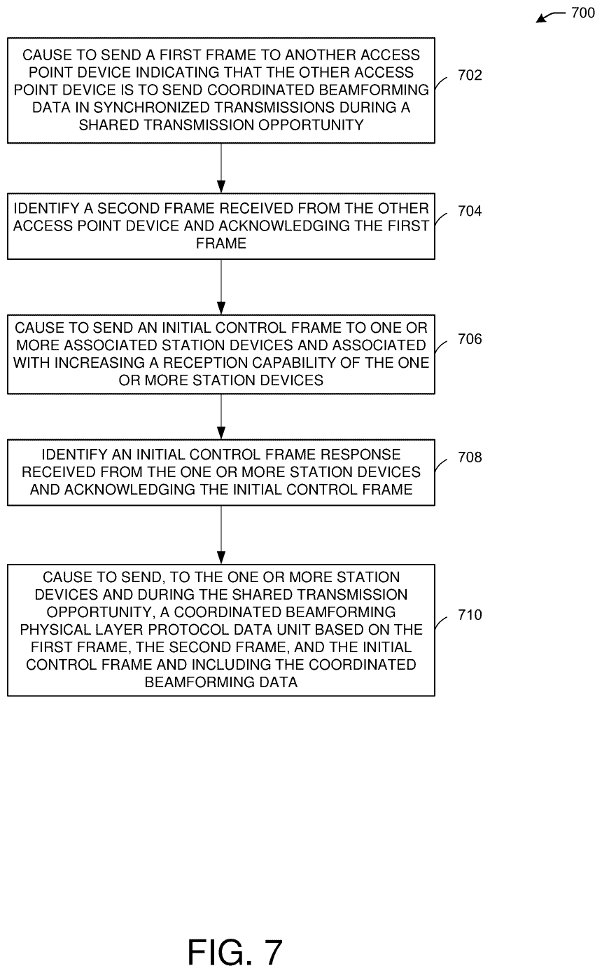

FIG. 7 shows an example process of a flow 700 for coordinated beamforming, in accordance with one or more embodiments of the present disclosure.

At block 702, a device (e.g., the sharing AP 204 of FIGS. 2-6C, the enhanced CBF device 919 of FIG. 9) may cause to send a first frame to a second AP device (e.g., the shared AP 206), the first frame indicating that the AP device and a second AP device are to send coordinated beamforming (CBF) data in synchronized transmissions during a transmission opportunity of the AP device.

At block 704, the device identify a second frame received from the second AP device, the second frame acknowledging the first frame and signaling parameters for the subsequent CBF transmissions.

At block 706, the device cause to send an initial control frame (ICF) to the one or more first STAs, wherein the ICF is associated with increasing a reception capability of one or more STAs associated to the AP device. The ICF may signal the CBF transmissions and may indicate to the one or more first STAs to increase reception capability for the CBF transmissions.

At block 708, the device may identify an initial control frame response (ICR) received from the one or more STAs acknowledging the ICF.

At block 710, the device may cause to send, to the one or more first STAs and during the transmission opportunity, a CBF physical layer protocol data unit (PPDU) based on the first frame, the second frame, and the ICR, wherein the CBF PPDU comprises the CBF data.

It is understood that the above descriptions are for purposes of illustration and are not meant to be limiting.

FIG. 8 shows a functional diagram of an exemplary communication station 300, in accordance with one or more example embodiments of the present disclosure. In one embodiment, FIG. 8 illustrates a functional block diagram of a communication station that may be suitable for use as an AP 102 (FIG. 1A) or a user device 120 (FIG. 1A) in accordance with some embodiments. The communication station 300 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 800 may include communications circuitry 802 and a transceiver 810 for transmitting and receiving signals to and from other communication stations using one or more antennas 801. The communications circuitry 802 may include circuitry that can operate the physical layer (PHY) communications and/or medium access control (MAC) communications for controlling access to the wireless medium, and/or any other communications layers for transmitting and receiving signals. The communication station 800 may also include processing circuitry 806 and memory 808 arranged to perform the operations described herein. In some embodiments, the communications circuitry 802 and the processing circuitry 806 may be configured to perform operations detailed in the above figures, diagrams, and flows.

In accordance with some embodiments, the communications circuitry 802 may be arranged to contend for a wireless medium and configure frames or packets for communicating over the wireless medium. The communications circuitry 802 may be arranged to transmit and receive signals. The communications circuitry 802 may also include circuitry for modulation/demodulation, upconversion/downconversion, filtering, amplification, etc. In some embodiments, the processing circuitry 806 of the communication station 800 may include one or more processors. In other embodiments, two or more antennas 801 may be coupled to the communications circuitry 802 arranged for sending and receiving signals. The memory 808 may store information for configuring the processing circuitry 806 to perform operations for configuring and transmitting message frames and performing the various operations described herein. The memory 808 may include any type of memory, including non-transitory memory, for storing information in a form readable by a machine (e.g., a computer). For example, the memory 808 may include a computer-readable storage device, read-only memory (ROM), random-access memory (RAM), magnetic disk storage media, optical storage media, flash-memory devices and other storage devices and media.

In some embodiments, the communication station 800 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 800 may include one or more antennas 801. The antennas 801 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 800 may include one or more of a keyboard, a display, a non-volatile memory port, multiple antennas, a graphics processor, an application processor, speakers, and other mobile device elements. The display may be an LCD screen including a touch screen.

Although the communication station 800 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 800 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 800 may include one or more processors and may be configured with instructions stored on a computer-readable storage device.

FIG. 9 illustrates a block diagram of an example of a machine 900 or system upon which any one or more of the techniques (e.g., methodologies) discussed herein may be performed. In other embodiments, the machine 900 may operate as a standalone device or may be connected (e.g., networked) to other machines. In a networked deployment, the machine 900 may operate in the capacity of a server machine, a client machine, or both in server-client network environments. In an example, the machine 900 may act as a peer machine in peer-to-peer (P2P) (or other distributed) network environments. The machine 900 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 900 may include a hardware processor 902 (e.g., a central processing unit (CPU), a graphics processing unit (GPU), a hardware processor core, or any combination thereof), a main memory 904 and a static memory 906, some or all of which may communicate with each other via an interlink (e.g., bus) 908. The machine 900 may further include a power management device 932, a graphics display device 910, an alphanumeric input device 912 (e.g., a keyboard), and a user interface (UI) navigation device 914 (e.g., a mouse). In an example, the graphics display device 910, alphanumeric input device 912, and UI navigation device 914 may be a touch screen display. The machine 900 may additionally include a storage device (i.e., drive unit) 916, a signal generation device 918 (e.g., a speaker), an enhanced CBF device 919, a network interface device/transceiver 920 coupled to antenna(s) 930, and one or more sensors 928, such as a global positioning system (GPS) sensor, a compass, an accelerometer, or other sensor. The machine 900 may include an output controller 934, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 902 for generation and processing of the baseband signals and for controlling operations of the main memory 904, the storage device 916, and/or the enhanced CBF device 919. The baseband processor may be provided on a single radio card, a single chip, or an integrated circuit (IC).

The storage device 916 may include a machine readable medium 922 on which is stored one or more sets of data structures or instructions 924 (e.g., software) embodying or utilized by any one or more of the techniques or functions described herein. The instructions 924 may also reside, completely or at least partially, within the main memory 904, within the static memory 906, or within the hardware processor 902 during execution thereof by the machine 900. In an example, one or any combination of the hardware processor 902, the main memory 904, the static memory 906, or the storage device 916 may constitute machine-readable media.

The enhanced CBF device 919 may carry out or perform any of the operations and processes (e.g., process 700) described and shown above.

It is understood that the above are only a subset of what the enhanced CBF device 919 may be configured to perform and that other functions included throughout this disclosure may also be performed by the enhanced CBF device 919.

While the machine-readable medium 922 is illustrated as a single medium, the term “machine-readable medium” may include a single medium or multiple media (e.g., a centralized or distributed database, and/or associated caches and servers) configured to store the one or more instructions 924.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 900 and that cause the machine 900 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 924 may further be transmitted or received over a communications network 926 using a transmission medium via the network interface device/transceiver 920 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 920 may include one or more physical jacks (e.g., Ethernet, coaxial, or phone jacks) or one or more antennas to connect to the communications network 926. In an example, the network interface device/transceiver 920 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 900 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

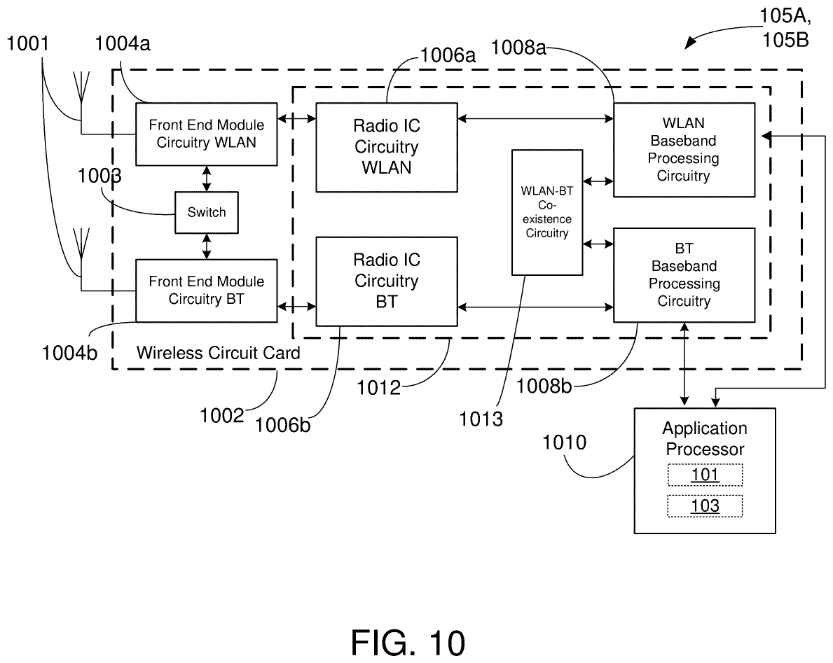

FIG. 10 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 1004a-b, radio IC circuitry 1006a-b and baseband processing circuitry 1008a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1004a-b may include a WLAN or Wi-Fi FEM circuitry 1004a and a Bluetooth (BT) FEM circuitry 1004b. The WLAN FEM circuitry 1004a may include a receive signal path comprising circuitry configured to operate on WLAN RF signals received from one or more antennas 1001, to amplify the received signals and to provide the amplified versions of the received signals to the WLAN radio IC circuitry 1006a for further processing. The BT FEM circuitry 1004b may include a receive signal path which may include circuitry configured to operate on BT RF signals received from one or more antennas 1001, to amplify the received signals and to provide the amplified versions of the received signals to the BT radio IC circuitry 1006b for further processing. FEM circuitry 1004a may also include a transmit signal path which may include circuitry configured to amplify WLAN signals provided by the radio IC circuitry 1006a for wireless transmission by one or more of the antennas 1001. In addition, FEM circuitry 1004b may also include a transmit signal path which may include circuitry configured to amplify BT signals provided by the radio IC circuitry 1006b for wireless transmission by the one or more antennas. In the embodiment of FIG. 10, although FEM 1004a and FEM 1004b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1006a-b as shown may include WLAN radio IC circuitry 1006a and BT radio IC circuitry 1006b. The WLAN radio IC circuitry 1006a may include a receive signal path which may include circuitry to down-convert WLAN RF signals received from the FEM circuitry 1004a and provide baseband signals to WLAN baseband processing circuitry 1008a. BT radio IC circuitry 1006b may in turn include a receive signal path which may include circuitry to down-convert BT RF signals received from the FEM circuitry 1004b and provide baseband signals to BT baseband processing circuitry 1008b. WLAN radio IC circuitry 1006a may also include a transmit signal path which may include circuitry to up-convert WLAN baseband signals provided by the WLAN baseband processing circuitry 1008a and provide WLAN RF output signals to the FEM circuitry 1004a for subsequent wireless transmission by the one or more antennas 1001. BT radio IC circuitry 1006b may also include a transmit signal path which may include circuitry to up-convert BT baseband signals provided by the BT baseband processing circuitry 1008b and provide BT RF output signals to the FEM circuitry 1004b for subsequent wireless transmission by the one or more antennas 1001. In the embodiment of FIG. 10, although radio IC circuitries 1006a and 1006b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1008a-b may include a WLAN baseband processing circuitry 1008a and a BT baseband processing circuitry 1008b. The WLAN baseband processing circuitry 1008a may include a memory, such as, for example, a set of RAM arrays in a Fast Fourier Transform or Inverse Fast Fourier Transform block (not shown) of the WLAN baseband processing circuitry 1008a. Each of the WLAN baseband circuitry 1008a and the BT baseband circuitry 1008b may further include one or more processors and control logic to process the signals received from the corresponding WLAN or BT receive signal path of the radio IC circuitry 1006a-b, and to also generate corresponding WLAN or BT baseband signals for the transmit signal path of the radio IC circuitry 1006a-b. Each of the baseband processing circuitries 1008a and 1008b may further include physical layer (PHY) and medium access control layer (MAC) circuitry, and may further interface with a device for generation and processing of the baseband signals and for controlling operations of the radio IC circuitry 1006a-b.

Referring still to FIG. 10, according to the shown embodiment, WLAN-BT coexistence circuitry 1013 may include logic providing an interface between the WLAN baseband circuitry 1008a and the BT baseband circuitry 1008b to enable use cases requiring WLAN and BT coexistence. In addition, a switch 1003 may be provided between the WLAN FEM circuitry 1004a and the BT FEM circuitry 1004b to allow switching between the WLAN and BT radios according to application needs. In addition, although the antennas 1001 are depicted as being respectively connected to the WLAN FEM circuitry 1004a and the BT FEM circuitry 1004b, embodiments include within their scope the sharing of one or more antennas as between the WLAN and BT FEMs, or the provision of more than one antenna connected to each of FEM 1004a or 1004b.

In some embodiments, the front-end module circuitry 1004a-b, the radio IC circuitry 1006a-b, and baseband processing circuitry 1008a-b may be provided on a single radio card, such as wireless radio card 1002. In some other embodiments, the one or more antennas 1001, the FEM circuitry 1004a-b and the radio IC circuitry 1006a-b may be provided on a single radio card. In some other embodiments, the radio IC circuitry 1006a-b and the baseband processing circuitry 1008a-b may be provided on a single chip or integrated circuit (IC), such as IC 1012.

In some embodiments, the wireless radio card 1002 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.1ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.11ax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 10, the BT baseband circuitry 1008b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHZ, 2.4 GHZ, 5 GHZ, and bandwidths of about 2 MHZ, 4 MHZ, 5 MHz, 5.5 MHZ, 6 MHz, 8 MHz, 10 MHZ, 20 MHz, 40 MHz, 80 MHZ (with contiguous bandwidths) or 80+80 MHz (160 MHZ) (with non-contiguous bandwidths). In some embodiments, a 920 MHz channel bandwidth may be used. The scope of the embodiments is not limited with respect to the above center frequencies however.

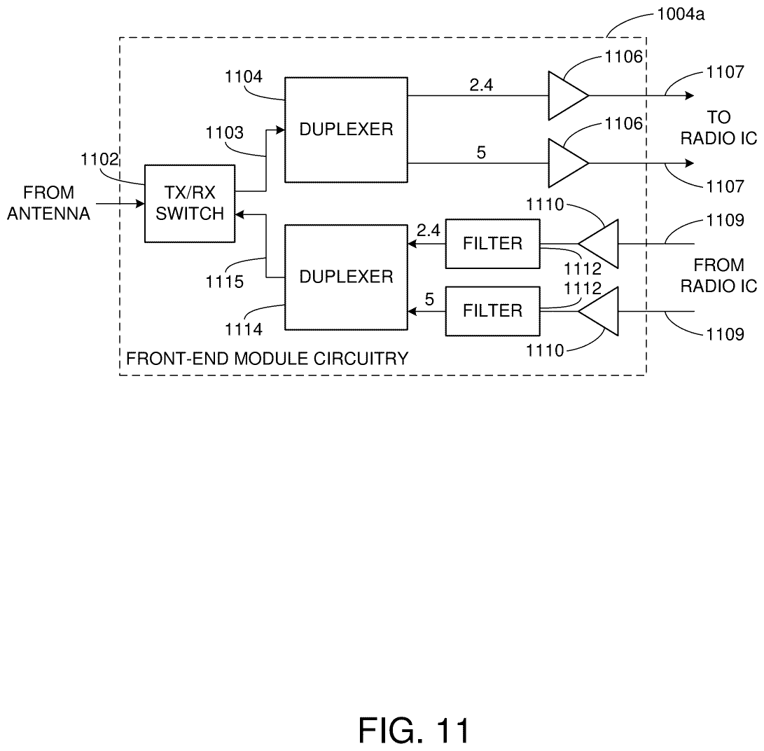

FIG. 11 illustrates WLAN FEM circuitry 1004a in accordance with some embodiments. Although the example of FIG. 11 is described in conjunction with the WLAN FEM circuitry 1004a, the example of FIG. 11 may be described in conjunction with the example BT FEM circuitry 1004b (FIG. 10), although other circuitry configurations may also be suitable.

In some embodiments, the FEM circuitry 1004a may include a TX/RX switch 1102 to switch between transmit mode and receive mode operation. The FEM circuitry 1004a may include a receive signal path and a transmit signal path. The receive signal path of the FEM circuitry 1104a may include a low-noise amplifier (LNA) 1106 to amplify received RF signals 1103 and provide the amplified received RF signals 1107 as an output (e.g., to the radio IC circuitry 1006a-b (FIG. 10)). The transmit signal path of the circuitry 1004a may include a power amplifier (PA) to amplify input RF signals 1109 (e.g., provided by the radio IC circuitry 1006a-b), and one or more filters 1112, such as band-pass filters (BPFs), low-pass filters (LPFs) or other types of filters, to generate RF signals 1115 for subsequent transmission (e.g., by one or more of the antennas 1001 (FIG. 10)) via an example duplexer 1114.

In some dual-mode embodiments for Wi-Fi communication, the FEM circuitry 1004a may be configured to operate in either the 2.4 GHz frequency spectrum or the 5 GHz frequency spectrum. In these embodiments, the receive signal path of the FEM circuitry 1004a may include a receive signal path duplexer 1104 to separate the signals from each spectrum as well as provide a separate LNA 1106 for each spectrum as shown. In these embodiments, the transmit signal path of the FEM circuitry 1004a may also include a power amplifier 1110 and a filter 1112, such as a BPF, an LPF or another type of filter for each frequency spectrum and a transmit signal path duplexer 1104 to provide the signals of one of the different spectrums onto a single transmit path for subsequent transmission by the one or more of the antennas 1001 (FIG. 10). In some embodiments, BT communications may utilize the 2.4 GHz signal paths and may utilize the same FEM circuitry 1004a as the one used for WLAN communications.

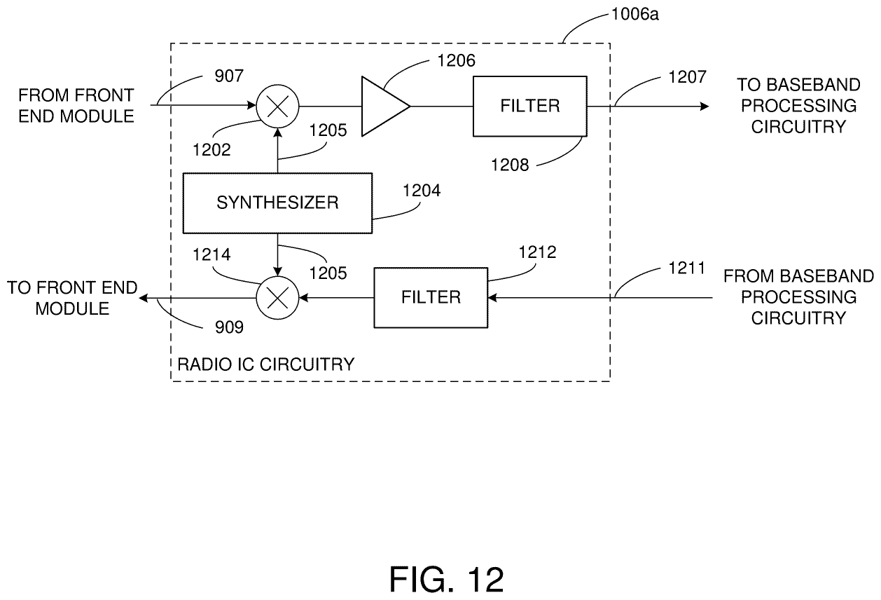

FIG. 12 illustrates radio IC circuitry 1006a in accordance with some embodiments. The radio IC circuitry 1006a is one example of circuitry that may be suitable for use as the WLAN or BT radio IC circuitry 1006a/1006b (FIG. 10), although other circuitry configurations may also be suitable. Alternatively, the example of FIG. 12 may be described in conjunction with the example BT radio IC circuitry 1006b.

In some embodiments, the radio IC circuitry 1006a may include a receive signal path and a transmit signal path. The receive signal path of the radio IC circuitry 1006a may include at least mixer circuitry 1202, such as, for example, down-conversion mixer circuitry, amplifier circuitry 1206 and filter circuitry 1208. The transmit signal path of the radio IC circuitry 1006a may include at least filter circuitry 1212 and mixer circuitry 1214, such as, for example, up-conversion mixer circuitry. Radio IC circuitry 1006a may also include synthesizer circuitry 1204 for synthesizing a frequency 1205 for use by the mixer circuitry 1202 and the mixer circuitry 1214. The mixer circuitry 1202 and/or 1214 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 12 illustrates only a simplified version of a radio IC circuitry, and may include, although not shown, embodiments where each of the depicted circuitries may include more than one component. For instance, mixer circuitry 1214 may each include one or more mixers, and filter circuitries 1208 and/or 1212 may each include one or more filters, such as one or more BPFs and/or LPFs according to application needs. For example, when mixer circuitries are of the direct-conversion type, they may each include two or more mixers.

In some embodiments, mixer circuitry 1202 may be configured to down-convert RF signals 1107 received from the FEM circuitry 1004a-b (FIG. 10) based on the synthesized frequency 1205 provided by synthesizer circuitry 1204. The amplifier circuitry 1206 may be configured to amplify the down-converted signals and the filter circuitry 1208 may include an LPF configured to remove unwanted signals from the down-converted signals to generate output baseband signals 1207. Output baseband signals 1207 may be provided to the baseband processing circuitry 1008a-b (FIG. 10) for further processing. In some embodiments, the output baseband signals 1207 may be zero-frequency baseband signals, although this is not a requirement. In some embodiments, mixer circuitry 1202 may comprise passive mixers, although the scope of the embodiments is not limited in this respect.

In some embodiments, the mixer circuitry 1214 may be configured to up-convert input baseband signals 1211 based on the synthesized frequency 1205 provided by the synthesizer circuitry 1204 to generate RF output signals 1109 for the FEM circuitry 1004a-b. The baseband signals 1211 may be provided by the baseband processing circuitry 1008a-b and may be filtered by filter circuitry 1212. The filter circuitry 1212 may include an LPF or a BPF, although the scope of the embodiments is not limited in this respect.

In some embodiments, the mixer circuitry 1202 and the mixer circuitry 1214 may each include two or more mixers and may be arranged for quadrature down-conversion and/or up-conversion respectively with the help of synthesizer 1204. In some embodiments, the mixer circuitry 1202 and the mixer circuitry 1214 may each include two or more mixers each configured for image rejection (e.g., Hartley image rejection). In some embodiments, the mixer circuitry 1202 and the mixer circuitry 1214 may be arranged for direct down-conversion and/or direct up-conversion, respectively. In some embodiments, the mixer circuitry 1202 and the mixer circuitry 1214 may be configured for super-heterodyne operation, although this is not a requirement.

Mixer circuitry 1202 may comprise, according to one embodiment: quadrature passive mixers (e.g., for the in-phase (I) and quadrature phase (Q) paths). In such an embodiment, RF input signal 1107 from FIG. 11 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1205 of synthesizer 1204 (FIG. 12). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction in power consumption.

The RF input signal 1107 (FIG. 11) may comprise a balanced signal, although the scope of the embodiments is not limited in this respect. The I and Q baseband output signals may be provided to low-noise amplifier, such as amplifier circuitry 1206 (FIG. 12) or to filter circuitry 1208 (FIG. 12).

In some embodiments, the output baseband signals 1207 and the input baseband signals 1211 may be analog baseband signals, although the scope of the embodiments is not limited in this respect. In some alternate embodiments, the output baseband signals 1207 and the input baseband signals 1211 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1204 may be a fractional-N synthesizer or a fractional N/N+1 synthesizer, although the scope of the embodiments is not limited in this respect as other types of frequency synthesizers may be suitable. For example, synthesizer circuitry 1204 may be a delta-sigma synthesizer, a frequency multiplier, or a synthesizer comprising a phase-locked loop with a frequency divider. According to some embodiments, the synthesizer circuitry 1204 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1204 may be provided by a voltage controlled oscillator (VCO), although that is not a requirement. A divider control input may further be provided by either the baseband processing circuitry 1008a-b (FIG. 10) depending on the desired output frequency 1205. In some embodiments, a divider control input (e.g., N) may be determined from a look-up table (e.g., within a Wi-Fi card) based on a channel number and a channel center frequency as determined or indicated by the example application processor 1010. The application processor 1010 may include, or otherwise be connected to, one of the example secure signal converter 101 or the example received signal converter 103 (e.g., depending on which device the example radio architecture is implemented in).

In some embodiments, synthesizer circuitry 1104 may be configured to generate a carrier frequency as the output frequency 1105, while in other embodiments, the output frequency 1105 may be a fraction of the carrier frequency (e.g., one-half the carrier frequency, one-third the carrier frequency). In some embodiments, the output frequency 1105 may be a LO frequency (fLO).

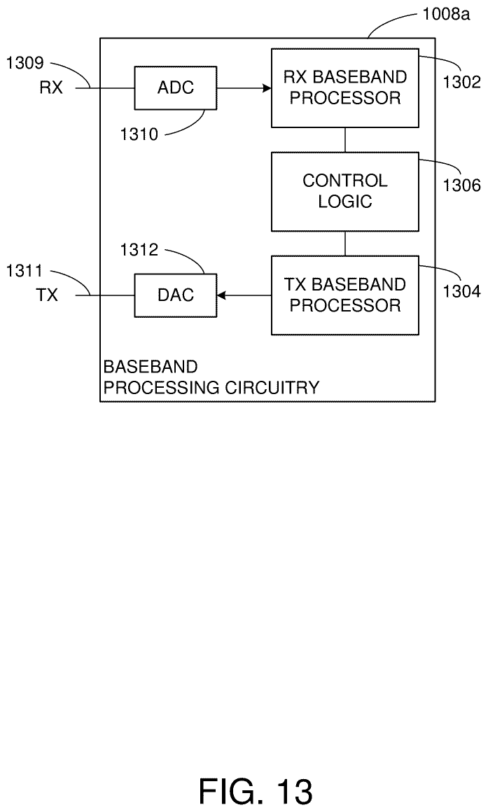

FIG. 13 illustrates a functional block diagram of baseband processing circuitry 1208a in accordance with some embodiments. The baseband processing circuitry 1008a is one example of circuitry that may be suitable for use as the baseband processing circuitry 1008a (FIG. 10), although other circuitry configurations may also be suitable. Alternatively, the example of FIG. 12 may be used to implement the example BT baseband processing circuitry 1008b of FIG. 10.

The baseband processing circuitry 1008a may include a receive baseband processor (RX BBP) 1302 for processing receive baseband signals 1209 provided by the radio IC circuitry 1006a-b (FIG. 10) and a transmit baseband processor (TX BBP) 1304 for generating transmit baseband signals 1211 for the radio IC circuitry 1006a-b. The baseband processing circuitry 1008a may also include control logic 1306 for coordinating the operations of the baseband processing circuitry 1008a.

In some embodiments (e.g., when analog baseband signals are exchanged between the baseband processing circuitry 1008a-b and the radio IC circuitry 1006a-b), the baseband processing circuitry 1008a may include ADC 1310 to convert analog baseband signals 1309 received from the radio IC circuitry 1006a-b to digital baseband signals for processing by the RX BBP 1302. In these embodiments, the baseband processing circuitry 1008a may also include DAC 1312 to convert digital baseband signals from the TX BBP 1304 to analog baseband signals 1311.

In some embodiments that communicate OFDM signals or OFDMA signals, such as through baseband processor 1008a, the transmit baseband processor 1304 may be configured to generate OFDM or OFDMA signals as appropriate for transmission by performing an inverse fast Fourier transform (IFFT). The receive baseband processor 1302 may be configured to process received OFDM signals or OFDMA signals by performing an FFT. In some embodiments, the receive baseband processor 1302 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 10, in some embodiments, the antennas 1001 (FIG. 10) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1001 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include an apparatus of an access point (AP) device for facilitating coordinated beamforming between AP devices, the apparatus comprising processing circuitry coupled to storage, the processing circuitry configured to: cause to send a first frame to a second AP device, the first frame indicating that the AP device and a second AP device are to send coordinated beamforming (CBF) data in synchronized transmissions during a transmission opportunity of the AP device; identify a second frame received from the second AP device, the second frame acknowledging the first frame; cause to send an initial control frame (ICF) to one or more STAs associated to the AP device, wherein the ICF is associated with increasing a reception capability of the one or more STAs; identify an initial control frame response (ICR) received from at least one of the one or more STAs and acknowledging the ICF; and cause to send, to the one or more STAs and during the transmission opportunity, a CBF physical layer protocol data unit (PPDU) based on the first frame and the second frame wherein the CBF PPDU comprises the CBF data and an indication of the one or more STAs.

Example 2 may include the apparatus of example 1 and/or any other example herein, wherein the processing circuitry is further configured to cause to send, to the second AP device, a CBF transmission indicating that the second AP device is to send a second CBF PPDU at a same time as the CBF PPDU, and wherein the CBF PPDU is sent based on the CBF transmission.

Example 3 may include the apparatus of example 2 and/or any other example herein, wherein the transmission comprises: an identifier of the AP device; an identifier of the second AP device; identifiers of all STAs scheduled in the first frame and the second frame; resource allocations of frequency, space, and time for the one or more STAs; and values or configuration parameters for a preamble of the CBF PPDU.

Example 4 may include the apparatus of example 2 and/or any other example herein, wherein the CBF transmission comprises: a first basic service set (BSS) color of the AP device; a second BSS color of the second AP device; punctured channel information; a duration of the transmission opportunity; a version of the CBF transmission; a number of UHR-SIG symbols of the CBF PPDU; and a total number of CBF users to receive the CBF PPDU and one or more additional CBF PPDUs.

Example 5 may include the apparatus of example 2 and/or any other example herein, wherein the CBF transmission indicates in each user info field of the one or more STAs whether 2× low-density parity-check (LDPC) is used.

Example 6 may include the apparatus of example 2 and/or any other example herein, wherein the CBF transmission is associated with estimating a carrier frequency offset (CFO) between the AP device and the second AP device, and wherein the CFO is associated with a second CBF PPDU transmitted by the second AP during the transmission opportunity.

Example 7 may include the apparatus of example 1 and/or any other example herein, wherein the CBF PPDU comprises a subfield of downlink uplink in a U-SIG field that is set to 0 to indicate a downlink transmission and a subfield of PPDU type and a compression mode in the U-SIG field that is set to 2 to indicate a non-OFDMA transmission.

Example 8 may include the apparatus of example 1 and/or any other example herein, wherein the processing circuitry is further configured to cause to send a CBF synchronization frame associated with allowing a clock of the second AP device to synchronize with a lock of the AP device, and wherein a second CBF PPDU is sent based on the synchronization.

Example 9 may include the apparatus of example 1 and/or any other example herein, wherein the ICF indicates that the one or more STAs are to wait until at least the CBF PPDU is received before entering a listen mode for enhanced multilink single-radio (EMLSR) operations.

Example 10 may include the apparatus of example 1 and/or any other example herein, wherein the ICF is indicative of a CBF sequence and comprises an indication of a time period during which the one or more STAs are to wait until before entering a listen mode for EMLSR operations.

Example 11 may include the apparatus of example 1 and/or any other example herein, wherein the processing circuitry is further configured to cause to send an extremely high throughput (EHT) sounding null data packet, and wherein the CBF PPDU is based on the EHT sounding null data packet.

Example 12 may include the apparatus of example 1 and/or any other example herein, further comprising a transceiver configured to transmit or receive signals comprising the first frame, second frame, ICF, ICR, and CBF PPDU.

Example 13 may include the apparatus of example 12 and/or any other example herein, further comprising an antenna coupled to the transceiver to cause to send the first frame, the ICF, and the CBF PPDU.

Example 14 may include a non-transitory computer-readable medium storing computer-executable instructions which when executed by one or more processors of an access point (AP) device result in performing operations comprising: causing to send a first frame to a second AP device, the first frame indicating that the AP device and a second AP device are to send coordinated beamforming (CBF) data in synchronized transmissions during a transmission opportunity of the AP device; identifying a second frame received from the second AP device, the second frame acknowledging the first frame; causing to send an initial control frame (ICF) to one or more STAs associated to the AP device, wherein the ICF is associated with increasing a reception capability of the one or more STAs; identifying an initial control frame response (ICR) received from at least one of the one or more STAs and acknowledging the ICF; and causing to send, to the one or more STAs and during the transmission opportunity, a CBF physical layer protocol data unit (PPDU) based on the first frame and the second frame, wherein the CBF PPDU comprises the CBF data and an indication of the one or more STAs.

Example 15 may include the non-transitory computer-readable medium of example 14 and/or any other example herein, the operations further comprising causing to send, to the second AP device, a CBF transmission indicating that the second AP device is to send a second CBF PPDU at a same time as the CBF PPDU, and wherein the CBF PPDU is sent based on the CBF transmission.

Example 16 may include the non-transitory computer-readable medium of example 15 and/or any other example herein, wherein the CBF t transmission comprises: an identifier of the AP device; an identifier of the second AP device; identifiers of all STAs scheduled in the first frame and the second frame; resource allocations of frequency, space, and time for the one or more STAs; and values or configuration parameters for a preamble of the CBF PPDU.

Example 17 may include the non-transitory computer-readable medium of example 15 and/or any other example herein, wherein the CBF transmission comprises: a first basic service set (BSS) color of the AP device; a second BSS color of the second AP device; punctured channel information; a duration of the transmission opportunity; a version of the CBF transmission; a number of UHR-SIG symbols of the CBF PPDU; and a total number of CBF users to receive the CBF PPDU and at least one additional CBF PPDU.

Example 18 may include the non-transitory computer-readable medium of example 15 and/or any other example herein, wherein the CBF transmission indicates in each user info field of the one or more STAs whether 2× low-density parity-check (LDPC) is used.

Example 19 may include the non-transitory computer-readable medium of example 15 and/or any other example herein, wherein the CBF transmission is associated with estimating a carrier frequency offset (CFO) between the AP device and the second AP device, and wherein the CFO is associated with a second CBF PPDU transmitted by the second AP during the transmission of the CBF PPDU and a second CBF PPDU.

Example 20 may include a method for adding or facilitating coordinated beamforming between access point (AP) devices, the method comprising: causing to send, by processing circuitry of a first AP device, a first frame to a second AP device, the first frame indicating that the first AP device and a second AP device are to send coordinated beamforming (CBF) data in synchronized transmissions during a transmission opportunity of the AP device; identifying, by the processing circuitry, a second frame received from the second AP device, the second frame acknowledging the first frame; causing to send, by the processing circuitry, an initial control frame (ICF) to one or more STAs associated to the AP device, wherein the ICF is associated with increasing a reception capability of the one or more STAs identifying, by the processing circuitry, an initial control frame response (ICR) received from at least one of the one or more STAs and acknowledging the ICF; and causing to send, by the processing circuitry and to the one or more STAs and during the transmission opportunity, a CBF physical layer protocol data unit (PPDU) based on the first frame and the second frame, wherein the CBF PPDU comprises the CBF data and an indication of the one or more STAs.

Example 21 may include an apparatus of a first AP device including means for: causing to send a first frame to a second AP device, the first frame indicating that the first AP device and a second AP device are to send coordinated beamforming (CBF) data in synchronized transmissions during a transmission opportunity of the AP device; identifying a second frame received from the second AP device, the second frame acknowledging the first frame; causing to send an initial control frame (ICF) to one or more STAs associated to the AP device, wherein the ICF is associated with increasing a reception capability of the one or more STAs identifying an initial control frame response (ICR) received from at least one of the one or more STAs and acknowledging the ICF; and causing to send, to the one or more STAs and during the transmission opportunity, a CBF physical layer protocol data unit (PPDU) based on the first frame and the second frame, wherein the CBF PPDU comprises the CBF data and an indication of the one or more STAs.

Example 22 may include one or more non-transitory computer-readable media comprising instructions to cause an electronic device, upon execution of the instructions by one or more processors of the electronic device, to perform one or more elements of a method described in or related to any of examples 1-21, or any other method or process described herein.

Example 23 may include an apparatus comprising logic, modules, and/or circuitry to perform one or more elements of a method described in or related to any of examples 1-21, or any other method or process described herein.

Example 24 may include a method, technique, or process as described in or related to any of examples 1-21, or portions or parts thereof.

Example 25 may include an apparatus comprising: one or more processors and one or more computer readable media comprising instructions that, when executed by the one or more processors, cause the one or more processors to perform the method, techniques, or process as described in or related to any of examples 1-21, or portions thereof.

Example 26 may include a method of communicating in a wireless network as shown and described herein.

Example 27 may include a system for providing wireless communication as shown and described herein.

Example 28 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. An apparatus of an access point (AP) device for facilitating coordinated beamforming between AP devices, the apparatus comprising processing circuitry coupled to storage, the processing circuitry configured to:
cause to send a first frame to a second AP device, the first frame indicating that the AP device and a second AP device are to send coordinated beamforming (CBF) data in synchronized transmissions during a transmission opportunity of the AP device;
identify a second frame received from the second AP device, the second frame acknowledging the first frame;
cause to send an initial control frame (ICF) to one or more STAs associated to the AP device, wherein the ICF is associated with increasing a reception capability of the one or more STAs;
identify an initial control frame response (ICR) received from at least one of the one or more STAs and acknowledging the ICF; and
cause to send, to the one or more STAs and during the transmission opportunity, a CBF physical layer protocol data unit (PPDU) based on the first frame and the second frame wherein the CBF PPDU comprises the CBF data and an indication of the one or more STAs.

2. The apparatus of claim 1, wherein the processing circuitry is further configured to cause to send, to the second AP device, a CBF transmission indicating that the second AP device is to send a second CBF PPDU at a same time as the CBF PPDU, and wherein the CBF PPDU is sent based on the CBF transmission.

3. The apparatus of claim 2, wherein the transmission comprises:
an identifier of the AP device;
an identifier of the second AP device;
identifiers of all STAs scheduled in the first frame and the second frame;
resource allocations of frequency, space, and time for the one or more STAs; and
values or configuration parameters for a preamble of the CBF PPDU.

4. The apparatus of claim 2, wherein the CBF transmission comprises:
a first basic service set (BSS) color of the AP device;
a second BSS color of the second AP device;
punctured channel information;
a duration of the transmission opportunity;
a version of the CBF transmission;
a number of UHR-SIG symbols of the CBF PPDU; and
a total number of CBF users to receive the CBF PPDU and one or more additional CBF PPDUs.

5. The apparatus of claim 2, wherein the CBF transmission indicates in each user info field of the one or more STAs whether 2× low-density parity-check (LDPC) is used.

6. The apparatus of claim 2, wherein the CBF transmission is associated with estimating a carrier frequency offset (CFO) between the AP device and the second AP device, and wherein the CFO is associated with a second CBF PPDU transmitted by the second AP during the transmission opportunity.

7. The apparatus of claim 1, wherein the CBF PPDU comprises a subfield of downlink uplink in a U-SIG field that is set to 0 to indicate a downlink transmission and a subfield of PPDU type and a compression mode in the U-SIG field that is set to 2 to indicate a non-OFDMA transmission.

8. The apparatus of claim 1, wherein the processing circuitry is further configured to cause to send a CBF synchronization frame associated with allowing a clock of the second AP device to synchronize with a lock of the AP device, and wherein a second CBF PPDU is sent based on the synchronization.

9. The apparatus of claim 1, wherein the ICF indicates that the one or more STAs are to wait until at least the CBF PPDU is received before entering a listen mode for enhanced multilink single-radio (EMLSR) operations.

10. The apparatus of claim 1, wherein the ICF is indicative of a CBF sequence and comprises an indication of a time period during which the one or more STAs are to wait until before entering a listen mode for EMLSR operations.

11. The apparatus of claim 1, wherein the processing circuitry is further configured to cause to send an extremely high throughput (EHT) sounding null data packet, and wherein the CBF PPDU is based on the EHT sounding null data packet.

12. The apparatus of claim 1, further comprising a transceiver configured to transmit or receive signals comprising the first frame, second frame, ICF, ICR, and CBF PPDU.

13. The apparatus of claim 12, further comprising an antenna coupled to the transceiver to cause to send the first frame, the ICF, and the CBF PPDU.

14. A non-transitory computer-readable medium storing computer-executable instructions which when executed by one or more processors of an access point (AP) device result in performing operations comprising:
causing to send a first frame to a second AP device, the first frame indicating that the AP device and a second AP device are to send coordinated beamforming (CBF) data in synchronized transmissions during a transmission opportunity of the AP device;
identifying a second frame received from the second AP device, the second frame acknowledging the first frame;
causing to send an initial control frame (ICF) to one or more STAs associated to the AP device, wherein the ICF is associated with increasing a reception capability of the one or more STAs;
identifying an initial control frame response (ICR) received from at least one of the one or more STAs and acknowledging the ICF; and
causing to send, to the one or more STAs and during the transmission opportunity, a CBF physical layer protocol data unit (PPDU) based on the first frame and the second frame, wherein the CBF PPDU comprises the CBF data and an indication of the one or more STAs.

15. The non-transitory computer-readable medium of claim 14, the operations further comprising causing to send, to the second AP device, a CBF transmission indicating that the second AP device is to send a second CBF PPDU at a same time as the CBF PPDU, and wherein the CBF PPDU is sent based on the CBF transmission.

16. The non-transitory computer-readable medium of claim 15, wherein the CBF t transmission comprises:
an identifier of the AP device;
an identifier of the second AP device;
identifiers of all STAs scheduled in the first frame and the second frame;
resource allocations of frequency, space, and time for the one or more STAs; and
values or configuration parameters for a preamble of the CBF PPDU.

17. The non-transitory computer-readable medium of claim 15, wherein the CBF transmission comprises:
a first basic service set (BSS) color of the AP device;
a second BSS color of the second AP device;
punctured channel information;
a duration of the transmission opportunity;
a version of the CBF transmission;
a number of UHR-SIG symbols of the CBF PPDU; and
a total number of CBF users to receive the CBF PPDU and at least one additional CBF PPDU.

18. The non-transitory computer-readable medium of claim 15, wherein the CBF transmission indicates in each user info field of the one or more STAs whether 2× low-density parity-check (LDPC) is used.

19. The non-transitory computer-readable medium of claim 15, wherein the CBF transmission is associated with estimating a carrier frequency offset (CFO) between the AP device and the second AP device, and wherein the CFO is associated with a second CBF PPDU transmitted by the second AP during the transmission of the CBF PPDU and a second CBF PPDU.

20. A method for adding or facilitating coordinated beamforming between access point (AP) devices, the method comprising:
causing to send, by processing circuitry of a first AP device, a first frame to a second AP device, the first frame indicating that the first AP device and a second AP device are to send coordinated beamforming (CBF) data in synchronized transmissions during a transmission opportunity of the AP device;
identifying, by the processing circuitry, a second frame received from the second AP device, the second frame acknowledging the first frame;
causing to send, by the processing circuitry, an initial control frame (ICF) to one or more STAs associated to the AP device, wherein the ICF is associated with increasing a reception capability of the one or more STAs
identifying, by the processing circuitry, an initial control frame response (ICR) received from at least one of the one or more STAs and acknowledging the ICF; and
causing to send, by the processing circuitry and to the one or more STAs and during the transmission opportunity, a CBF physical layer protocol data unit (PPDU) based on the first frame and the second frame, wherein the CBF PPDU comprises the CBF data and an indication of the one or more STAs.
